(19) United States
(12) Patent Application Publication
(10) Pub. No.: US 2026/0024753 A1
(43) Pub. Date: Jan. 22, 2026

(54) SEGREGATING PRIMARY NANOPARTICLES WITH SURFACE COATING-NETWORKING ARCHITECTURE FOR HIGH VOLTAGE CATHODE LIFE AT HIGH RATE

(71) Applicant: UNIVERSITY OF TENNESSEE RESEARCH FOUNDATION, Knoxville, TN (US)

(72) Inventors: Manikandan Palanisamy, Knoxville, TN (US); Douglas Aaron, Oak Ridge, TN (US); Matthew Mench, Knoxville, TN (US)

(73) Assignee: UNIVERSITY OF TENNESSEE RESEARCH FOUNDATION, Knoxville, TN (US)

(21) Appl. No.: 18/662,357

(22) Filed: May 13, 2024

Related U.S. Application Data
(63) Continuation-in-part of application No. 18/653,500, filed on May 2, 2024, now abandoned.
(60) Provisional application No. 63/466,954, filed on May 16, 2023.
(60) Provisional application No. 63/572,569, filed on Apr. 1, 2024.

(51) Int. Cl. H01M 4/36; C01G 53/54; H01M 4/505; H01M 4/62; H01M 10/052; H01M 10/42

(52) U.S. Cl. CPC H01M 4/366; C01G 53/54; H01M 4/505; H01M 4/625; H01M 10/052; H01M 10/4235; C01P 2002/32; C01P 2002/50; C01P 2002/72; C01P 2004/03; C01P 2004/04; C01P 2004/50; C01P 2004/61; C01P 2004/64; C01P 2004/80; C01P 2006/40

(57) ABSTRACT

A lithium battery is provided which includes an anode and a cathode, wherein the cathode includes lithium manganese nickel oxide spinel having a dual particle structure, the dual particle structure including primary nanoparticles having a mean particle size of less than nanometers segregated from secondary microparticles having a mean particle size of at least one micron, wherein the primary nanoparticles are coated with a polymer coating and connected using a conducting network. A corresponding cathode material for a lithium battery, and a method of making a cathode material, are also provided.

### RELATED APPLICATIONS

This patent application is a continuation-in-part of U.S. patent application Ser. No. 18/653,500, filed on May 2, 2024, and also claims the benefit of U.S. Provisional Application 63/572,569, filed on Apr. 1, 2024, and U.S. Provisional Application 63/466,954, filed on May 16, 2023. The disclosures of the foregoing applications are incorporated by reference.

### STATEMENT REGARDING FEDERALLY SPONSORED RESEARCH

This invention was made with government support under W911NF2220007 awarded by the U.S. Department of Defense. The government has certain rights in the invention.

### TECHNICAL FIELD

This application relates to the development and use of spinel lithium-manganese-nickel oxide cathode material having primary nanoparticles segregated from secondary microparticles, and surface modified by a polymer layer and conducting network for high-voltage cathode life at high rate. The application also includes an optimized synthesis method using precursor structural advancement, which enables least degree of disordered phase formation with insignificant content of Mn³⁺, minimizes capacity fade during high-rate cycling for use in a lithium-ion battery.

### BACKGROUND

The generic term “lithium batteries,” though commonly used, encompasses six different types of lithium chemistry, each of which rely on different active materials and chemical reactions to store energy. Lithium iron phosphate batteries employ lithium iron phosphate as the cathode material and a graphite carbon electrode as the anode and have a nominal voltage of 3.2 volts. The resulting batteries have a long use life (at least 2000 cycles), good thermal stability, and safety, and are commonly used to replace lead acid batteries in conventional applications.

Lithium cobalt oxide batteries use lithium cobalt oxide in the cathode and graphite in the anode. These batteries are used on modern consumer electronic applications such as laptops, tablets, cell phones, and digital cameras. The batteries have high specific energy which enables them to deliver power for extended periods in low load applications. However, these batteries have shorter lifespans (typically 500-1000 cycles), relatively low thermal stability, and are expensive due to the cobalt. They also have low specific power limits and are not suitable for high load applications.

Lithium nickel cobalt aluminum oxide batteries use lithium nickel cobalt aluminum oxide in the cathode and graphite in the anode. They have high specific energy with good power output and a long lifespan. These batteries are suitable for electric vehicles and other high load, relatively high-cost applications that require long battery life.

Lithium manganese oxide batteries use lithium manganese oxide in the cathode and graphite in the anode. These batteries charge quickly, offer high specific power, and can deliver high current as well as having good thermal stability, safety, and reasonably long lifespans. They are useful in power tools and some medical instruments as well as some hybrid vehicles, however it causes stability issues during long-term cycles.

Lithium nickel manganese cobalt oxide batteries use lithium nickel manganese cobalt oxide in the cathode and graphite in the anode. These batteries offer high specific energy, high energy density and thermal stability, and relatively long-life cycles. These batteries are used in electronic power trains for scooters and electronic bicycles, and some power tools.

Lithium titanate batteries are unique in that they replace the graphite in the anode with lithium titanate. They typically use lithium manganese oxide in the cathode. These batteries offer long lifespan, rapid charging, and high thermal stability and safety. These batteries are commonly used for aerospace and military equipment, telecommunication systems, electric vehicle charging stations, and other applications that require long-term or uninterrupted power sources.

One challenge associated with conventional lithium batteries is the diminished battery capacity that results from repeated cycling. As the batteries become older and endure repeated cycles of discharge and charge, their energy storage capacity gradually diminishes, and the time required for discharge correspondingly decreases. There is a need or desire for a lithium battery that has a more stable structure electrode materials, resulting in reduced capacity fade during cycling, and which also has a high charging capacity and high energy density for use in high-discharge rate applications.

### SUMMARY

The present invention is directed to a lithium battery including an anode and a cathode, wherein the cathode comprises spinel lithium manganese nickel oxide having a dual particle structure. Primary nanoparticles are segregated from secondary microparticles and are surface modified with a polymer layer and a conducting network for superior electrochemical performance at high voltage. Secondary microparticles are derived using a Mn_{1.5}Ni_{0.5}(OH)₂CO₃ precursor that undergoes thermal decomposition and calcination, releasing gaseous species of CO₂ and H₂O. In-situ high-temperature phase elucidation confirms a least degree of disordered phase spinel LiMn_{1.5}Ni_{0.5}O₄ cathode without a rock-salt impurity phase, having an insignificant content of Mn³⁺ for stable Fd3̅m structure, shows greater electronic and ionic conductivities compared to primitive simple cubic structure of ordered phase with P4₁32 space group symmetry.

Raman spectrum shows a band at 590 cm⁻¹ (F_{2g}⁽³⁾) without splitting, confirming spinel compound derived with disordered phase. Microscopic analyses reveal secondary microparticles and segregated primary nanoparticles having surface coating-conducting network architecture. Cyclic voltammograms of primary nanoparticles show well resolved two redox peaks at 4.7 V than secondary microparticles, confirming superior kinetic reversibility for Ni²⁺ to Ni³⁺ and Ni³⁺ to Ni⁴⁺ redox process. Segregated primary nanoparticles are shown to clear two flat voltage plateaus at 4.7 V and delivered reversible capacity of 112 mAh g⁻¹ for the 10^{th} cycle and 100 mAh g⁻¹ for the 500^{th} cycle at 1 C. At 20 C discharge, the primary nanoparticles exhibited a discharge flat voltage profile at 4.3 V and delivered high reversible capacity of 100 mAh g⁻ for the 12^{th} cycle and 86 mAh g⁻¹ for the 1000^{th} cycle. In contrast, the secondary microparticles delivered 70 mAh g⁻¹ for the 12^{th} cycle and declined their cycle operation at 250^{th} cycle with a capacity of <5 mAh g⁻¹. Thus, segregated primary nanoparticles with a surface-coating of PMMA+PVdF polymer layer and conducting network of CNT have a strong potential for use as a highly durable, cobalt-free, high voltage cathode capable of high-rate discharge in lithium ion batteries (“LIBs”).

The resulting spinel LiMn_{1.5}Ni_{0.5}O₄ cathode having segregated primary nanoparticles addresses drawbacks of conventional lithium-based cathodes especially (i) depletion of cobalt resources, and (ii) skyrocketing high energy and power demands; by delivering a high-voltage plateau at 4.7 V to attain entire theoretical capacity of 146 mAh g⁻¹ and producing high gravimetric energy density of 650 Wh kg⁻¹ compared to commercialized cathodes for lithium-ion batteries including LiCoO₂ (3.9 V, 145 mAh g⁻¹, 532 Wh kg⁻¹), LiFePO₄ (3.4 V, 169 mAh g⁻, 495 Wh kg⁻¹), LiNi_{1/3}Mn_{1/3}Co_{1/3}O₂ (4 V, 180 mAh g⁻¹, 576 Wh kg⁻¹), LiNiO₂ (4 V, 100 mAh g⁻¹, 629 Wh kg⁻¹), LiMn₂O₄ (4 V, 120 mAh g⁻¹, 440 Wh kg⁻¹), LiNi_{0.8}Co_{0.15}Al_{0.05}O₂ (4 V, 220 mAh g⁻¹, 600 Wh kg⁻¹) and LiNi_{0.8}Mn_{0.1}Co_{0.1}O₂ (4 V, 200 mAh g⁻¹, 630 Wh kg⁻¹). The invention also provides three-dimensional pathways for fast Li⁺ ion diffusion at high current density discharge. These features promote the spinel LiMn_{1.5}Ni_{0.5}O₄ cathode as a promising candidate for high-power applications, including without limitation electrification of aircraft (electric vertical take-off and landing—eVTOL), automobiles (electric vehicles—EVs), and large-scale high-power energy storage systems (HPESS) that are promising for sustainable evergreen environments by reducing decarbonization.

Prior to the invention, spinel LiMn_{1.5}Ni_{0.5}O₄ cathodes had not achieved commercialization widely for lithium-ion battery (“LIB”) applications due to the limitations of crystallographic metal sites, microstructure morphology, planes, insignificant Mn³⁺ ions for Fd3̅m structure and submicron particle size preventing fast Li⁺ ion transport at high-rate charge-discharge cycling. The spinel LiMn_{1.5}Ni_{0.5}O₄ cathodes being with specified limitations manganese suffers with Jahn-Teller distortion effects at high voltage (4.7 V). Based on the synthesis conditions, spinel LiMn_{1.5}Ni_{0.5}O₄ cathode forms two types of crystallographic structures belonging to the primitive simple cubic structure of ordered phase with P4₁32 space group symmetry and face-centered cubic structure of disordered phase with Fd3̅m space group symmetry, attributed to different properties of structural evolutions and electrochemical characteristics. The ordered phase P4₁32 is stoichiometric with Mn⁴⁺, while the disordered phase Fd3̅m nonstoichiometric with a trace amount of Mn³⁺ generated by oxygen releasing from the crystalline lattice at high-temperature calcination >750° C., which is not replenished completely in the cooling process. The existence of Mn³⁺ in the least disordered phase structure reduces activation energy for an increment of electronic conductivity compared to stoichiometric ordered phase containing Mn⁴⁺ ions. Thus, the disordered phase containing a trace amount of Mn³⁺ reveals greater electronic and ionic conductivities, higher Li⁺ ion diffusion coefficient, and stronger electrochemical performance than the stoichiometric ordered phase.

The key factors between the two structures are interstitial sites sharing. In the ordered phase, Li⁺ ions occupy tetrahedral 8a sites and O²⁻ ions are located at 8c and 24e sites, transition metals Mn⁴⁺ and Ni²⁺ are located at the 12d and 4b octahedral sites, while disordered phase (LiMn_{1.5}Ni_{0.5}O_{4-δ}) has a random distribution of Mn⁴⁺ and Ni²⁺ ions located at 16d octahedral interstitial sites, Li⁺ ions reside at tetrahedral 8a sites and O²⁻ ions occupied cubic 32e sites, respectively. The cation ordering in the structure is greatly influenced by the calcination temperature, viz., structure of LiMn_{1.5}Ni_{0.5}O₄ cathode will transform from ordered phase to disorder phase when the calcination temperature is increased from 700 to 800° C. A trace amount of oxygen loss during calcination at >750° C. is compensated by the formation of rock-salt impurity phase (LiₓNi₁₋ₓO₂oxygen vacancies, and a trace amount of Mn³⁺ ions.

The impurity phase LiₓNi₁₋ₓO₂ and the presence of Mn³⁺ ions, accelerate structural degradation of the disordered phase (Fd3̅m) during prolong charge-discharge cycling process and hinder large-scale production for the LIB applications. Hence, structural stability of the disordered phase can be improved by the existence of the least degree of structural disorder and Mn³⁺ ions. Previously, research and developments have been focused on different types of polyhedral particle morphologies; surface modification with Al₂O₃, ZrO₂, SiO₂, MgO, ZnO, CeO₂, and TiO₂; cation substitution of Mn/Ni ratio by Fe³⁺, Cr³⁺, Ga³⁺, and Nb⁵⁺, creation of various nanostructured architectures viz, hollow structure, nanoparticles, nanorods and core-shell structure and different types of particle facets to minimize structural disorder in Fd3̅m type and stabilize the structure by limiting undesirable electrochemical side reactions for prolong cycling stability. Cation substitution for Mn/Ni ratio mitigates the transition-metal dissolution and eliminates the rock-salt impurity phase formation. The Fe³⁺ substitution (LiMn_{1.475}Ni_{0.476}Fe_{0.049}O₄) generates Mn/Ni disorder structure by reduction of Mn⁴⁺ ions to increase conductivity, which stabilizes the disordering of Mn⁴⁺ and Ni²⁺ ions in the octahedral 16d sites of Fd3̅m structure and delivers high reversible capacity of 108 mAh g⁻¹ compared to pristine LiMn_{1.512}Ni_{0.488}O₄ cathode reversible capacity of 30 mAh g⁻¹ at 5 C, thereby confirming that the least disorder phase shows high electrochemical performance. Although reducing the degree of disorder structure and rock-salt LiₓNi₁₋ₓO₂ impurity phase, to enhance durability the crystal morphology and the particle size are also affect the ability to achieve high discharge rate and its long-term cycles. Submicron particles hinder fast Li⁺ ion transport due to their higher Li⁺ ion diffusion length and reduce high rate capability, while nanoparticles exhibit promising rate capability, but react easily with electrolytes due to high surface area resulting and cause electrochemical in side reactions especially at high voltage (4.7 V) during high-rate long-term charge-discharge cycles.

Secondary microparticles have been developed with high packing density composed of primary nanoparticles and have a less specific surface area for excellent electrochemical stability. The secondary microparticle contains clustered primary nanoparticles that limit the direct electrolyte contact of cathode particles and enhance the electrochemical stability of the spinel LiMn_{1.5}Ni_{0.5}O₄ cathode. The secondary microparticles deliver reversible capacity of 141 mAh g⁻¹ at 0.3 C with a very flat-voltage profile at 4.7 V corresponding to 96% of the total theoretical capacity of 146 mAh g⁻¹. However, the large volume of the secondary microparticle creates high internal stress as a result generates mechanical cracking and pulverization during prolonged high-rate charge-discharge cycling studies. Hence, secondary microparticles and their crystal morphology suffer from higher Li⁺ ion diffusion length, decreased Li⁺ ion pathways, electrode charge transfer resistance build-up, and polarization. For these reasons, the secondary microparticles delivered less capacity of 30 mAh g⁻¹ at 10 C compared to 141 mAh g⁻¹ at 0.3 C and showed fuzzy cycling stability at >10 C, ultimately preventing the large-scale production of spinel LiMn_{1.5}Ni_{0.5}O₄ cathode. Thus, even though several approaches have been developed to enhance disorder phase stability, commercialization of the spinel LiMn_{1.5}Ni_{0.5}O₄ cathode has been very challenging and requires a novel strategy to improve cycle life and rate-performance combining high energy and power densities towards the next generation of cobalt-free LIBs for high-power applications of eVTOL, EVs, and HPESS.

In accordance with the present invention, secondary microparticles were converted into primary nanoparticles having surface coating-networking architecture, resulting in remarkable electrochemical performance for high-voltage LIBs. High crystalline secondary microparticles were developed without the rock-salt impurity phase (LiₓNi₁₋ₓO₂) and having minimized disorder structure, using a Mn_{1.5}Ni_{0.5}(OH)₂CO₃ precursor. The segregated primary nanoparticles showed pronounced clear splitting at 4.7 V and confirming enhanced kinetic redox performance compared to the secondary microparticles. Ultimately, the primary nanoparticles delivered stable charge and discharge capacities with clear two flat-voltage profiles at 4.7 V at 1 C and achieved prolonged cycling stability for 1-1000 cycles at 20 C discharge with a capacity retention of 82%, compared to the less than 1% for the secondary microparticles. The conversion of secondary microparticles to primary nanoparticles represents a significant step toward the commercialization of spinel LiMn_{1.5}Ni_{0.5}O₄ cathode having improved high-voltage cathode life, high-rate performance, and high energy and power densities.

With the foregoing in mind, it is a feature and advantage of the invention to provide a lithium battery including an anode and a high voltage cathode (>4.5 V), wherein the cathode includes lithium manganese nickel oxide spinel having a dual particle structure.

It is also a feature and advantage of the invention to provide a lithium-ion battery including an anode and a cathode, wherein the cathode includes lithium manganese nickel oxide spinel having a dual particle structure, the dual particle structure including primary nanoparticles having a mean particle size of less than 50 nanometers, segregated from secondary microparticles having a mean particle size of at least one micron, wherein the primary nanoparticles are coated with a polymer coating and connected with a conducting network.

It is also a feature and advantage of the invention to provide a cathode material for a lithium battery, including lithium manganese nickel oxide spinel having a dual particle structure, the dual particle structure including primary nanoparticles having a mean particle size of less than 50 nanometers, segregated from secondary microparticles having a mean particle size of at least one micron, wherein the primary nanoparticles are coated with a polymer coating.

It is also a feature and advantage of the invention to provide a method of preparing a cathode material, including the steps of:
preparing secondary microparticles of spinel lithium manganese nickel oxide having a mean particle size of at least one micron;
segregating the microparticles into primary nanoparticles having a mean particle size of less than about 50 nanometers;
applying a polymer coating on the primary nanoparticles; and connecting the primary nanoparticles together using a conducting network.

The foregoing and other features and advantages will become further apparent from the following detailed description, read in conjunction with the accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a schematic illustration on secondary microparticles converted into primary for high-voltage cathode life at a high rate: (a) Mn(NO₃)₂·4H₂O and Ni(NO₃)₂·6H₂O; (b) NaOH and Na₂CO₃; (c) Mn_{1.5}Ni_{0.5}(OH)₂CO₃ precursor consisting of OH⁻ and (CO₃)²⁻ anions; (d) powder X-ray diffraction patterns of Mn_{1.5}Ni_{0.5}(OH)₂CO₃ precursor and blend homogenized blend with Li₂CO₃, undergoes thermal decomposition and calcination as given in Equation-1; (e) schematized secondary microparticles; (f) derived secondary microparticles of spinel LiMn_{1.5}Ni_{0.5}O₄ cathode; (g) segregation and surface modification with coating and networking using PMMA+PVdF and CNTs; (h) schematics for segregated primary nanoparticles; (i) segregated primary nanoparticles with PMMA+PVdF and CNTs; (j) kinetic reversible CV studies for redox processes of Ni²⁺→Ni³⁺ and Ni³⁺→Ni⁴⁺ for secondary microparticles and crystalline primary nanoparticles; and (k) high rate prolong cycle studies for secondary microparticles and primary nanoparticles.

FIG. 2 is a collection of graphs showing precursor phase changes upon temperature increment and structural elucidation: (a) Thermogravimetric analysis of homogenized blend containing Mn_{1.5}Ni_{0.5}(OH)₂CO₃ and Li₂CO₃ precursors yielded spinel LiMn_{1.5}Ni_{0.5}O₄ cathode between room temperature to 950° C. in an air atmosphere; powder X-ray diffraction patterns between 10-80° (2θ) for (b) mixed hydroxy carbonate precursor (dark blue), homogenized mixture (pink), heat-treated samples at 100° C. (violet), 200° C. (purple), 300° C. (orange), 400° C. (green), and 500° C. (cyan); (c) calcined samples at 500° C. for 12 h (cyan), 800° C. for 12 h (blue), and 900° C. (maroon) for 12 h investigated with the standard pattern of spinel LiMn_{1.5}Ni_{0.5}O₄ cathode belong to ICSD #98-007-0023 (pink); in-situ high-temperature powder X-ray analyses between 10°-50° (2θ) for (d) ramping from 25° C. to 800° C.; (e) dwelling at 800° C. for 12 h; (f) cooling from 800° C. to 200° C.; (g) Rietveld refinement analyses of the sample derived at 800° C. for 12 h; (h) schematic illustrations of the 3D framework structure for the derived spinel LiMn_{1.5}Ni_{0.5}O₄ cathode material is demonstrated with lithium (purple), manganese/nickel (blue), and oxygen (red), viewed in (111), (100) and (110) planes; and powder X-ray diffraction pattern of (i) secondary microparticles for the spinel LiMn_{1.5}Ni_{0.5}O₄ cathode (blue) and segregated primary nanoparticles (green) compared with the standard pattern of ICSD #98-007-0023 (pink) for spinel LiMn_{1.5}Ni_{0.5}O₄ cathode.

FIG. 3 is a field-emission scanning electron microscopic analyses for disordered phase spinel LiMn_{1.5}Ni_{0.5}O₄ cathode: (a) secondary microparticles morphology; (b) well dispersed spherical shape secondary microparticles with the size of ˜1 μm; (c) secondary microparticle composed of primary nanoparticles with the size of <50 nm; (d) energy dispersive X-ray spectrum of secondary particle revealed pronounced signals for the presence of Mn, Ni and O elements in the spinel LiMn_{1.5}Ni_{0.5}O₄ cathode, derived at 800° C. for 12 h and quantified the atomic percentage of Mn and Ni with ˜3:1 ratio; (e) FESEM image for simultaneous elemental mapping analyses, confirming presence of (f) Mn (purple), (g) Ni (orange), and (h) O (green) elements; (i) segregated primary nanoparticles with surface coating of PMMA+PVdF polymer layer and conducting network of MWCNT is showed surface smoothness; (j) well-aligned nanoparticles in a pattern; (k) segregated primary nanoparticles with the size of <50 nm; (l) energy dispersive X-ray spectrum of segregated primary nanoparticles revealed pronounced signals for the presence of Mn, Ni and O elements in the spinel LiMn_{1.5}Ni_{0.5}O₄ cathode, and quantified the atomic percentage of Mn and Ni with ˜3:1 ratio; (m) FESEM image for simultaneous elemental mapping analyses, confirming presence of (n) Mn (purple), (o) Ni (orange), and (p) O (green) elements.

FIG. 4 is a high-resolution transmission electron microscopic analyses for micro to nano architecture: (a) Secondary microparticles; (b) secondary microparticle with the size of ˜1 μm; (c) packed densely with primary nanoparticles; (d) composed of different polyhedra shapes of primary nanoparticles; (e) spherical shape; (f) hexagonal shape; (g) enlarged view of hexagonal flake; (h) fast Fourier-transform image corresponding to the hexagonal flake; (i) HRTEM image for SAED; (j) depicts bright diffraction spots indicating high crystallinity; (k) segregated primary nanoparticles; (l) well-dispersed primary nanoparticles are surface modified with PMMA+PVdF and CNTs; (m) primary nanoparticles are connected well with CNTs; (n) different polyhedra shapes are networked with CNTs; (o) size of segregated primary nanoparticles show ˜50 nm with CNTs; (p) primary nanoparticles with surface polymer layer coating; (q) polymer layer coating of PMMA+PVdF covered on primary nanoparticles; (r) polymer layer shows amorphous characteristics; (s) HRTEM image of segregated primary nanoparticles for SAED; (t) displayed bright diffraction spots and rings confirming crystallinity of the segregated primary nanoparticles and the conducting network of CNTs.

FIG. 5 is a collection of graphs showing kinetic reversibility and Li⁺ ion transport characteristics for secondary microparticles and primary nanoparticles: Cyclic voltammograms of (a) Li vs. secondary microparticles; (b) Li vs. primary nanoparticles; (c) high voltage redox peaks of secondary microparticles and primary nanoparticles compared between 3.0 to 4.9 V at 0.05 mV s⁻¹ for 1-5 cycles; Nyquist plots of fresh cell and after 5 cycles CV for (d) secondary microparticles, lithium cells assembled with secondary microparticles/primary nanoparticles cathode, lithium metal foil, Celgard polypropylene separator and a mixture solution contains 98% of 1M LiPF₆ in EC+December (1:1 vol %) electrolyte and 2% of fluoroethylene carbonate (FEC) additive; (e) primary nanoparticles in the range of 300 kHz to 20 mHz at 10 mV amplitude,; and (f) schematic illustrations of kinetic reversibility and Li⁺ ion transport for polyhedra microparticle, secondary microparticle and segregated primary nanoparticles.

FIG. 6 is a collection of graphs showing galvanostatic charge-discharge cycling studies for secondary microparticles and primary nanoparticles: Voltage vs. capacity performance of wide voltage range between 3.0-4.9 V at 1 C (a) Li vs. secondary microparticles; (b) Li vs. primary nanoparticles; (c) clear two flat voltage plateaus comparison between secondary microparticles and primary nanoparticles for 10^{th} cycle; high voltage range between 4.0-4.9 V at 1 C (d) Li vs. secondary microparticles; (e) Li vs. primary nanoparticles; (f) clear two flat voltage plateaus comparison between secondary microparticles and primary nanoparticles for 100^{th} cycle; and (g) Galvanostatic charge-discharge cycling studies for secondary microparticles and primary nanoparticles of disordered phase spinel LiMn_{1.5}Ni_{0.5}O₄ cathode derived at 800° C. for 12 h, compared between wide voltage range (3.0-4.9 V) and high voltage range (4.0-4.9 V) at 1 C for 1-500 cycles. Lithium cells assembled with the cathode of secondary microparticles/primary nanoparticles, lithium metal foil (˜100 μm thickness), Celgard polypropylene separator and a mixture solution contains 98% of 1M LiPF₆ in EC+December (1:1 vol %) electrolyte and 2% of fluoroethylene carbonate (FEC) additive.

FIG. 7 is a collection of graphs showing galvanostatic high rate cycling studies for secondary microparticles and primary nanoparticles: Voltage vs. capacity profiles for fabricated lithium cells (a) Li vs. secondary microparticles; (b) Li vs. primary nanoparticles; (c) capacity vs. cycle number rate comparison of secondary microparticles and primary nanoparticles at 1 C charge and discharge at 1 C, 2 C, 3 C, 5 C, 10 C, 15 C and 20 C for 1-80 cycles between 3.0-4.9 V; prolong charge-discharge high rate cycling studies proceeded with initial stabilization cycles at 1 C charge and 1 C discharge for 1-10 cycles and then high-rate cycles at 1 C charge and 20 C discharge for 11-1000 cycles between 3.0-4.9 V (d) Li vs. secondary microparticles; (e) Li vs. primary nanoparticles; (f) schematic illustrations of secondary microparticle and segregated primary nanoparticles for fast Li⁺ ion diffusion and transport kinetic features; and (g) Galvanostatic prolong charge-discharge high rate cycling studies for secondary microparticles and primary nanoparticles of disordered phase spinel LiMn_{1.5}Ni_{0.5}O₄ cathode, at 1 C charge and discharge at 1 C, 2 C, 3 C, 5 C, 10 C, 15 C and 20 C, between 3.0-4.9 V for 1-1000 cycles. Lithium cells assembled with the cathode of secondary microparticles/primary nanoparticles, lithium metal foil (˜100 μm thickness), Celgard polypropylene separator and a mixture solution contains 98% of 1M LiPF₆ in EC+December (1:1 vol %) electrolyte and 2% of fluoroethylene carbonate (FEC) additive.

FIG. 8 is a graph showing Fourier-transform infrared spectroscopic spectra of spinel LiMn_{1.5}Ni_{0.5}O₄ cathode derived at 800° C. for 12 h (blue) and segregated primary nanoparticles of spinel LiMn_{1.5}Ni_{0.5}O₄ cathode, surface modified with polymer coating PMMA+PVdF and conducting network MWCNTs (green).

FIG. 9 is a graph showing Raman spectra of spinel LiMn_{1.5}Ni_{0.5}O₄ cathode derived at 800° C. for 12 h (blue) and segregated primary nanoparticles of spinel LiMn_{1.5}Ni_{0.5}O₄ cathode, surface modified with polymer coating PMMA+PVdF and conducting network MWCNTs (green).

FIG. 10 is a field-emission scanning electron microscopic analyses of (a) Mn_{1.5}Ni_{0.5}(OH)₂CO₃ precursor exhibits secondary microparticles morphology, (b) well dispersed spherical shape secondary microparticles with the size of ˜0.5 μm, (c) primary nanoparticles with the size of <50 nm, (d) FESEM image of quantified area for energy dispersive X-ray analysis, (e) energy dispersive X-ray spectrum of Mn_{1.5}Ni_{0.5}(OH)₂CO₃ precursor showed pronounced signals for the presence of Mn, Ni and O elements and quantified the atomic percentage of Mn and Ni with ˜3:1 ratio, FESEM image for simultaneous elemental mapping analyses confirm presence of (f) Mn (purple), (g) Ni (orange) and (h) O (green) elements.

FIG. 11 is a field-emission scanning electron microscopic analyses of (a) spinel LiMn_{1.5}Ni_{0.5}O₄ cathode derived at 500° C. for 12 h exhibits secondary microparticles morphology, (b) well dispersed spherical shape secondary microparticles with the size of ˜1 μm, (c) primary nanoparticles with the size of <50 nm, (d) FESEM image of quantified area for energy dispersive X-ray analysis, (e) energy dispersive X-ray spectrum of spinel LiMn_{1.5}Ni_{0.5}O₄ cathode derived at 500° C. for 12 h showed pronounced signals for the presence of Mn, Ni and O elements and quantified the atomic percentage of Mn and Ni with ˜3:1 ratio, FESEM image for simultaneous elemental mapping analyses, confirm presence of (f) Mn (purple), (g) Ni (orange) and (h) O (green) elements.

FIG. 12 is a field-emission scanning electron microscopic analyses of (a) spinel LiMn_{1.5}Ni_{0.5}O₄ cathode derived at 900° C. for 12 h exhibits secondary microparticles morphology, (b) well dispersed spherical shape secondary microparticles with the size of ˜1 μm, (c) primary nanoparticles with the size of <50 nm, (d) FESEM image of quantified area for energy dispersive X-ray analysis, (e) energy dispersive X-ray spectrum of spinel LiMn_{1.5}Ni_{0.5}O₄ cathode derived at 900° C. for 12 h showed pronounced signals for the presence of Mn, Ni and O elements and quantified the atomic percentage of Mn and Ni with ˜3:1 ratio, FESEM image for simultaneous elemental mapping analyses, confirm presence of (f) Mn (purple), (g) Ni (orange) and (h) O (green) elements.

FIG. 13 shows the voltage vs capacity profiles of spinel LiMn_{1.5}Ni_{0.5}O₄ cathode derived at (a) 500° C. for 12 h, (b) 900° C. for 12 h and (c) Galvanostatic charge-discharge cycling performance of spinel LiMn_{1.5}Ni_{0.5}O₄ cathode derived at 500° C. for 12 h and 900° C. for 12 h at 1 C between 3.5-4.9 V for 500° C. for 12 h (1-20 cycles) and 3.0-4.9 V for 900° C. for 12 h (1-100 cycles). The lithium cells assembled with the respective electrode (spinel LiMn_{1.5}Ni_{0.5}O₄ cathode derived at 500° C./900° C.), lithium metal foil (˜100 μm thickness), Celgard polypropylene separator and a mixture solution contains 98% of 1M LiPF₆ in EC+December (1:1 vol %) electrolyte and 2% of fluoroethylene carbonate (FEC) additive.

### DETAILED DESCRIPTION

The following detailed description will illustrate the general principles of the invention, examples of which are additionally illustrated in the accompanying drawings. In the drawings, like references indicate identical or functionally similar elements.

Except in the working examples, or where otherwise explicitly indicated, all numbers in this description indicating amounts, parts, percentages, ratios, and proportions of material, physical properties of material, and conditions of reaction are to be understood as modified by the word “about.” “About” as used herein means that a value is preferably +/−5% or more preferably +/−2%. Percentages for concentrations are typically % by wt. For pH values, “about” means +/−0.2.

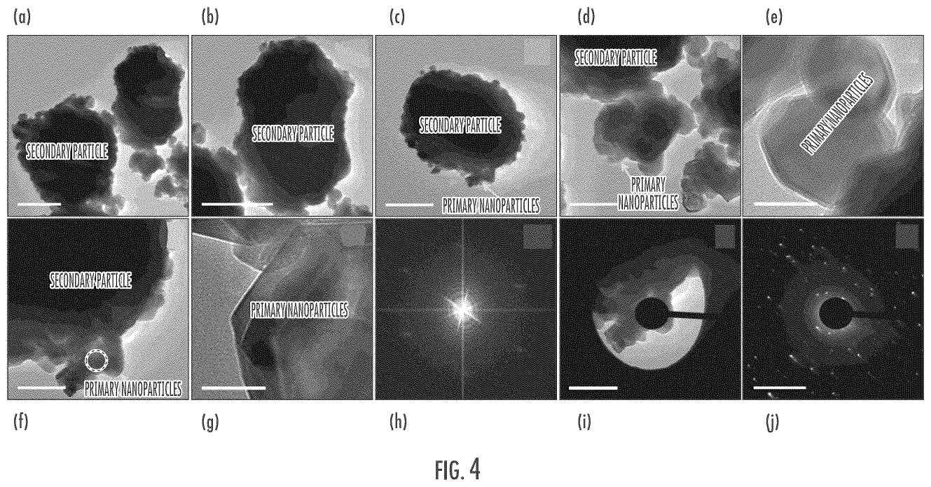

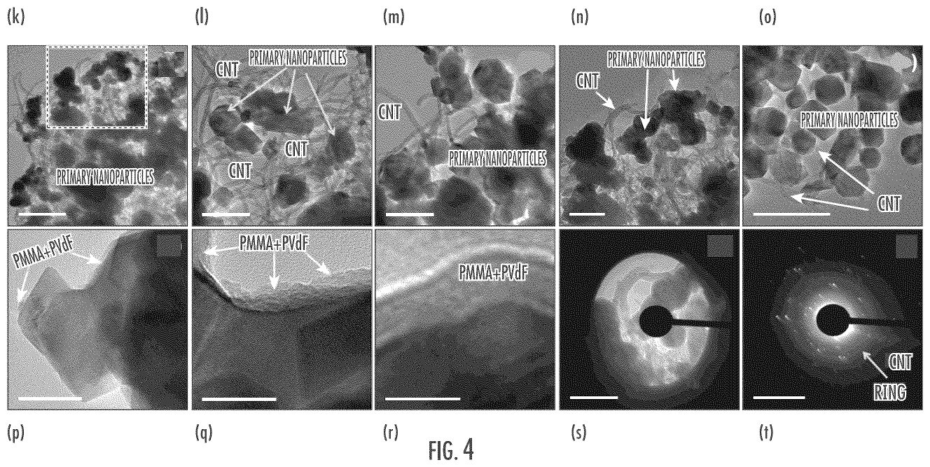

The invention encompasses a structural enhancement and phase change resulting in a conversion of secondary microparticles into primary nanoparticles of lithium manganese nickel oxide spinel, yielding a dual particle structure that includes primary nanoparticles and secondary microparticles together. Referring to FIG. 4, for example, the primary nanoparticles can have a mean particle size of less than 50 nm, or up to about 48 nm, or up to about 45 nm, or up to about 42 nm, or up to about 40 nm, and/or at least about 1 nm, or at least about 5 nm, or at least about 10 nm, or at least about 15 nm, or at least about 20 nm. The secondary microparticles can have a mean particle diameter of at least one micron, or at least about 1.05 micron, or at least about 1.1 micron, or at least about 1.15 micron, or at least about 1.2 micron, or at least about 1.25 micron, and/or up to about 2 microns, or up to about 1.9 micron, or up to about 1.8 micron, or up to about 1.7 micron, or up to about 1.6 micron, or up to about 1.5 micron. Particle sizes can be measured using a standard technique, and can be measured using ASTM D422, which is incorporated by reference.

The primary nanoparticles can constitute about 10% to about 90% by weight of the dual particle structure, or about 15% to about 85% by weight, or about 20% to about 80% by weight, or about 25% to about 75% by weight, or about 30% to about 70% by weight. The secondary microparticles can constitute about 10% to about 90% by weight of the dual particle structure, or about 15% to about 85% by weight, or about 20% to about 80% by weight, or about 25% to about 75% by weight, or about 30% to about 70% by weight.

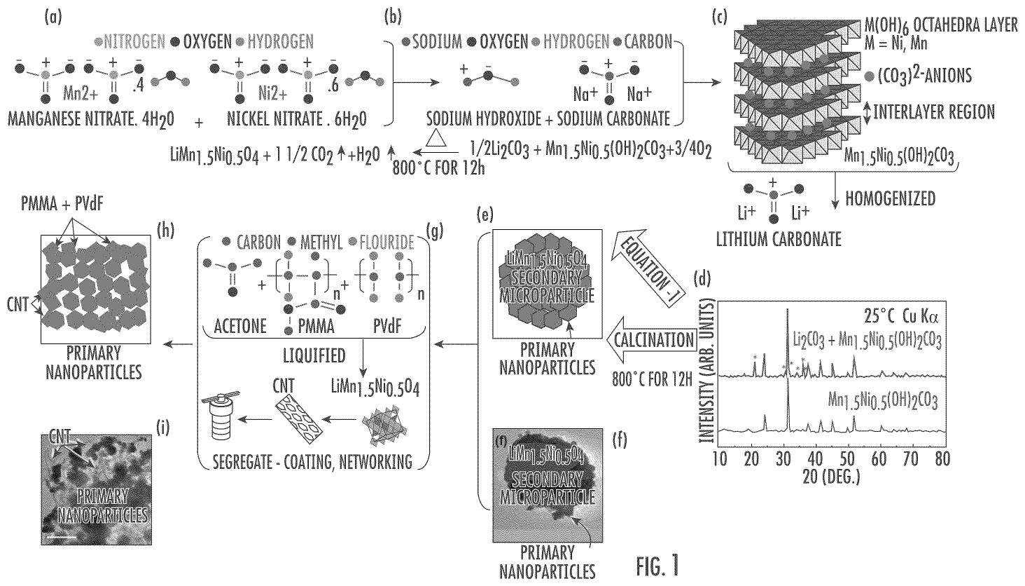

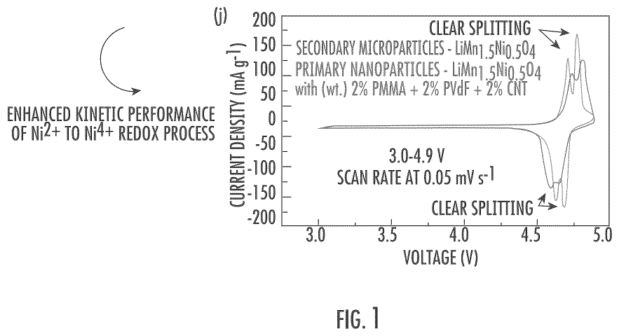

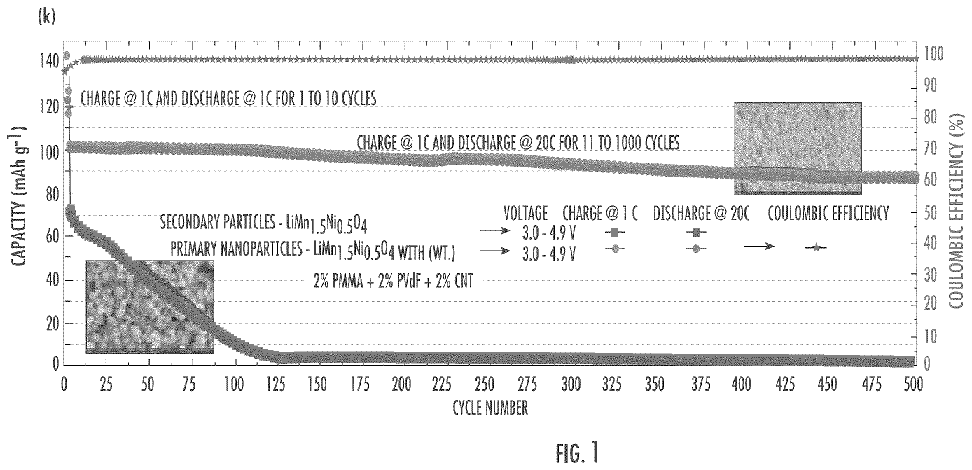

This disclosure demonstrates the progress of secondary microparticles converted into primary nanoparticles having surface coating-networking architecture for high-voltage cathode life at a high rate, as shown in FIG. 1. In one embodiment, a stoichiometric aqueous solution of Mn(NO₃)₂·4H₂O and Ni(NO₃)₂·6H₂O (FIG. 1a) was added to a solution of 2 m NaOH and 1 m Na₂CO₃ (FIG. 1b) at 40° C., yielding a toxic free mixed hydroxy carbonate (MHC) precursor viz., Mn_{1.5}Ni_{0.5}(OH)₂CO₃ having OH and (CO₃)²⁻ anions, as shown in FIG. 1c. Stoichiometric amounts of Mn_{1.5}Ni_{0.5}(OH)₂CO₃ and Li₂CO₃ precursors were homogenized and the precursor phases were confirmed using powder X-ray diffraction patterns (FIG. 1d). The precursor blend was calcined at 800° C. for 12 hours in an air atmosphere and the MHC precursor produced well-dispersed LiMn_{1.5}Ni_{0.5}O₄ secondary microparticles composed of primary nanoparticles (FIG. 1e-f) by releasing gas species of CO₂ and H₂O during the thermal decomposition and calcination processes, as explained in Equation 1 (FIG. 1). Next, the secondary microparticles were added into a polymer solution of polymethyl methacrylate (PMMA) and polyvinylidene fluoride (PVdF) binders dissolved in acetone with vigorous stirring for 1 hour in a Teflon-lined autoclave. After dispersion of secondary microparticles in the polymer solution, multi-walled carbon nanotubes (MWCNTs) were added to the mixture solution and the autoclave was stirred well for 12 hours at 70° C., then placed in an oven for 10 hours at 90° C. (FIG. 1g). After cooling the autoclave, acetone solvent was evaporated at 60° C. with stirring resulting in primary nanoparticles with the surface coating of PMMA+PVdF with a conducting network (MWCNTs) architecture, being segregated from the secondary microparticles, as shown in FIG. 1h-i. In the autoclave reactor, the primary nanoparticles segregated from the secondary microparticles by pressure built-up of acetone solvent evaporation at 70° C. with vigorous stirring and further heating in an oven at 90° C. The resulting spinel LiMn_{1.5}Ni_{0.5}O₄ cathode included well-dispersed crystalline primary nanoparticles having a surface coating-networking architecture, showing enhanced kinetic redox processes of Ni²⁺→Ni³⁺ and Ni³⁺→Ni²⁺ (FIG. 1j) and prolonged cycle stability compared to the secondary microparticles (FIG. 1k), as further described below.

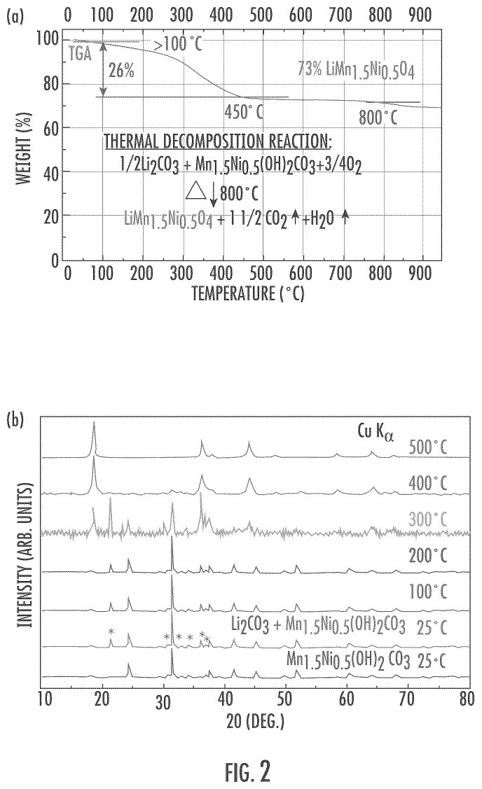

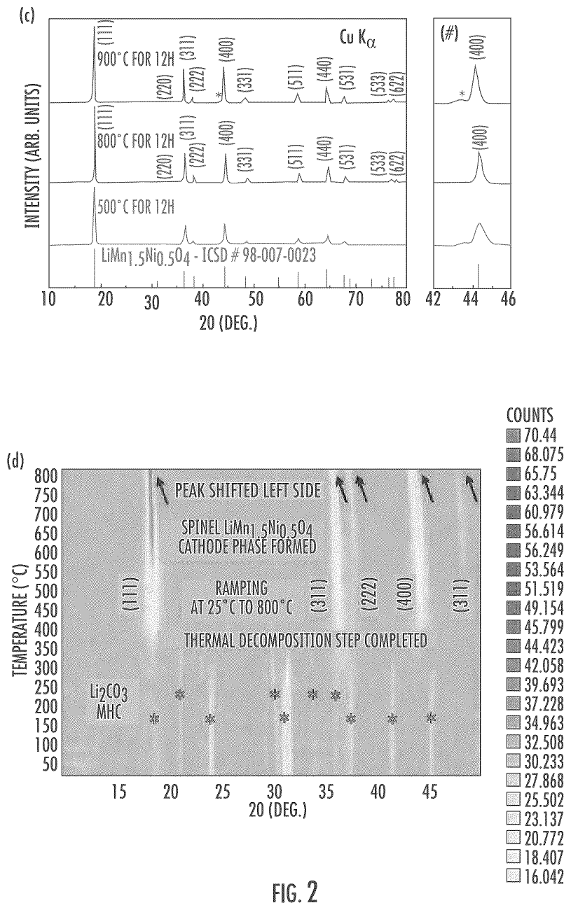

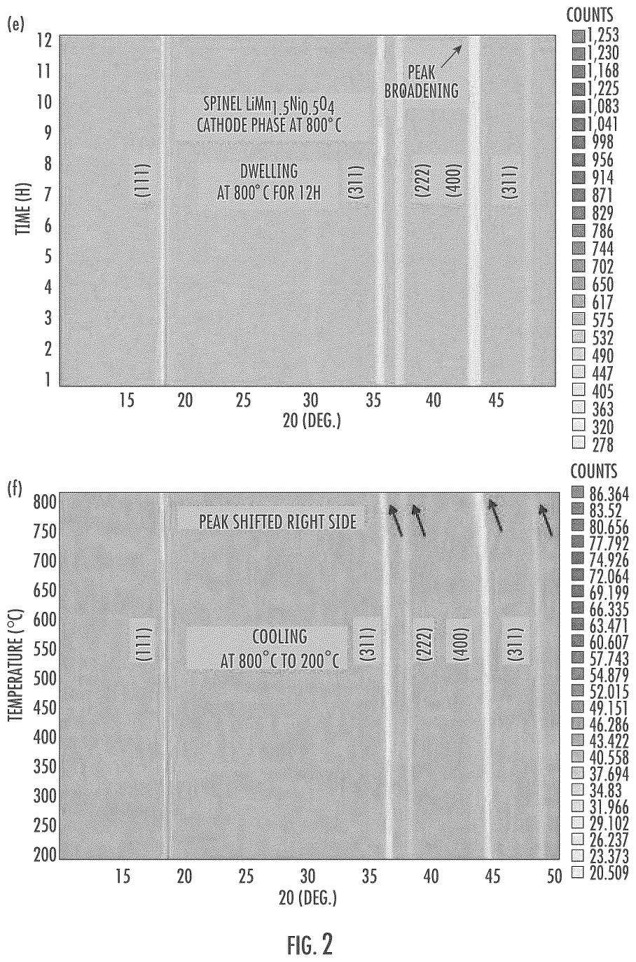

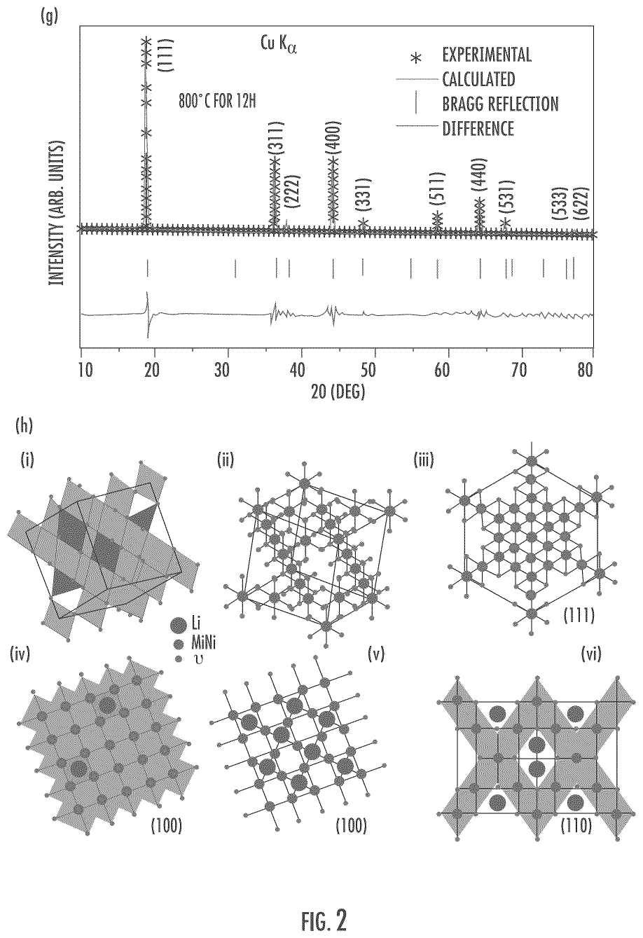

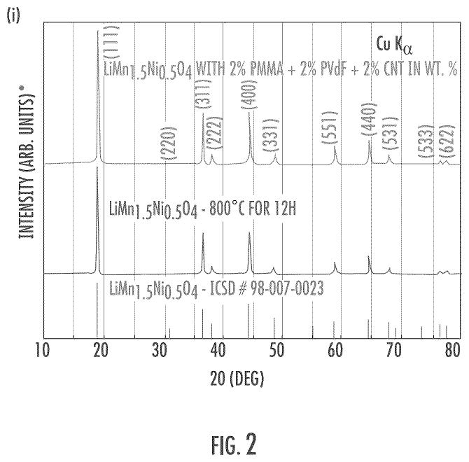

Thermogravimetric analysis (TGA) of the homogenized blend containing stoichiometric amounts of Mn_{1.5}Ni_{0.5}(OH)₂CO₃ and Li₂CO₃ precursors was performed between room temperature and to 950° C. in an air atmosphere to evaluate precursor thermal decomposition and the formation of the spinel LiMn_{1.5}Ni_{0.5}O₄ cathode material, as shown in FIG. 2a. A weight loss of 26% between 100° C. to 450° C. occurred with a slope profile in the thermogravimetric (TG) curve, attributed to the simultaneous thermal decomposition and oxidation of the homogenized mixture precursor by release of gas species CO₂ and H₂O, as given in Equation 1. At temperatures above 450° C., the TG curve was observed with a straight line corresponding to the residue weight of 73% indicating spinel LiMn_{1.5}Ni_{0.5}O₄ cathode formation and stable up to 800° C. A weight loss of about 2% at above 800° C. to 950° C. indicates Li⁺ ion loss due to evaporation at high temperature during heat treatment and confirms disorder phase formation of the spinel LiMn_{1.5}Ni_{0.5}O₄ cathode.

From the TG results, it determined the homogenized precursor's blend thermal decomposition and calcination temperature limit for least disordered phase formation with trace amount of Mn³⁺ ion in spinel LiMn_{1.5}Ni_{0.5}O₄ cathode. Referring to FIG. 2b, Powder X-ray diffraction patterns (XRD) were recorded between 10-80° (2θ) for MHC precursor (lowest line, dark blue), homogenized mixture (second line, pink), heat-treated samples at 100° C. (third line, violet), 200° C. (fourth line, purple), 300° C. (fifth line, orange), 400° C. (sixth line, green), and 500° C. (top line, cyan) to confirm the thermal decomposition reaction. The observed broad diffraction peaks of the heat-treated sample at 500° C. (top line, cyan) indicated the formation of the spinel LiMn_{1.5}Ni_{0.5}O₄ cathode phase and the completion of thermal decomposition, which was confirmed by the absence of precursor phases in the XRD. When increasing the dwelling time duration at 500° C., the intensity of the diffraction peak was also increased and produces high crystalline spinel LiMn_{1.5}Ni_{0.5}O₄ cathode.

Referring to FIG. 2c, to examine the phase changes upon extended time duration, powder XRD patterns of calcined samples were taken at 500° C. (second line, cyan), 800° C. (third line, blue), and 900° C. (top line, maroon) for 12 hours using the standard pattern of ICSD #98-007-0023. The lowest line pink shows the peaks for standard pattern of spinel LiMn_{1.5}Ni_{0.5}O₄ cathode. The intensity of the sample heated at 500° C. for 12 hours shown in FIG. 2c (second line, cyan) increased and was sharper than the sample heated at 500° C. for 15 minutes, as shown in FIG. 2b (top line, cyan). The calcination temperature has a considerable influence on Ni and Mn cation ordering in the structure and produced disordered phase spinel LiMn_{1.5}Ni_{0.5}O₄ cathode (Fd3̅m structure) at above 750° C., containing a trace amount of Mn³⁺ for greater electronic and ionic conductivities for stronger electrochemical performance. Hence, the homogenized mixture calcined at 800° C. and 900° C. for 12 hours and indexed with the standard pattern ICSD #98-007-0023 falls within the Fd3̅m space group for spinel LiMn_{1.5}Ni_{0.5}O₄ cathode, as depicted in FIG. 2c. The sample calcined at 900° C. for 12 hours revealed a left-shifted peak (400) with a rock-salt impurity phase peak at 43.4° (LiₓNi₁₋ₓO₂, indicated in FIG. 2c with asterisk), while the sample calcined at 800° C. for 12 hours confirmed trace amount of Mn³⁺ ions present in the disordered phase (Fd3̅m structure) to reduce the distortion.

Next, in situ high temperature phase analysis and structural elucidation for the disordered phase were analyzed. In-situ high-temperature powder XRD patterns were recorded between 10°-50° (2θ) for ramping from 25° C. to 800° C. (FIG. 2d), dwelling at 800° C. for 12 h (FIG. 2e), and cooling from 800° C. to 200° C. (FIG. 2f), and confirmed phase changes from the precursors to the disordered phase spinel LiMn_{1.5}Ni_{0.5}O₄ cathode. Referring to FIG. 2d, the Li₂CO₃ precursor phase peaks at 21.3°, 30.5°, 33.7° and 36° (2θ) were observed from room temperature to 300° C., as indicated in asterisks, blue, while MHC precursor phase peaks were detected at 19°, 24°, 31.5°, 37.5°, 41.5° and 45° (2θ), also indicated in asterisks, pink. The precursor phases were thermally decomposed completely between 300° C. to 350° C. and formed the spinel LiMn_{1.5}Ni_{0.5}O₄ cathode phase at 400° C. with peak broadening for (111), (311), (222), (400) and (331) planes, as depicted with less intensity in yellow (20 counts s⁻¹, FIG. 2d). Upon temperature increase, the broadening of the (111), (311) and (400) peaks decreased and become sharper at 750° C. with high intensity, as denoted in red (46 counts s⁻¹, FIG. 2d). Above 750° C., the planes (111), (311), (222), (400) and (331) shifted towards left side due to Li⁺ ion evaporation at high temperature and forming disordered phase spinel LiMn_{1.5}Ni_{0.5}O₄ cathode, as determined by a weight loss at above 800° C. in the TG curve for Li⁺ ion evaporation.

As shown FIG. 2e, during dwelling at 800° C. for 12 hours, there was no further left side peak shifting and the peak broadening for (400) plane was stable for 12 hours. During cooling, the peak broadening of the (111), (311), (222), (400) and (331) planes decreased and became sharper with high intensity (60 counts s⁻¹ for the (111) plane), as shown in FIG. 2f. Significantly, right side peak shifting observed for the (111), (311), (222), (400) and (331) planes from 800° C. to 750° C. corresponds to the formation of disordered phase spinel LiMn_{1.5}Ni_{0.5}O₄ cathode material having trace amounts of Mn³⁺, which corresponds to the disordered phase formed due to Lit ion loss at high temperature and retention of oxygen vacancies during cooling process. After cooling, the peaks at 18.8°, 36.4°, 38°, 44.3° and 48.5° (2θ) for the (111), (311), (222), (400) and (331) planes (FIG. 2f) were exactly matched with the ex-situ powder XRD pattern of the sample calcined at 800° C. for 12 h (FIG. 2c, middle, blue), confirming that the disordered spinel LiMn_{1.5}Ni_{0.5}O₄ cathode phase has formed with Fd3̅m structure, as shown in FIG. 2f. Thus, the in-situ XRD results for the thermal decomposition and calcination process of the precursor blend confirmed the disordered phase spinel LiMn_{1.5}Ni_{0.5}O₄ cathode formation and correlated with obtained TGA (FIG. 2a) and ex-situ XRD results (FIG. 2b-c).

To determine the disordered phase structure of the derived material, Rietveld refinement analyses were performed by GSAS software to the powder XRD pattern of the sample derived at 800° C. for 12 hours (asterisks in black for experimental), as shown in FIG. 2g. The obtained diffractions peaks were well indexed with the Bragg reflection represented in vertical line (pink) for the spinel LiMn_{1.5}Ni_{0.5}O₄ cathode belong to Fd3̅m space group (ICSD #98-007-0023). The calculated lattice parameter values a=8.1692 Å (α=β=γ=90°) and the unit cell volume V=545.19 Å³ showed good agreement with the disordered phase structure of spinel LiMn_{1.5}Ni_{0.5}O₄ cathode with the goodness of fit χ²=2.1 and R-factor R_{wp}=2% and the crystallographic atomic parameters in Table 1.

Table 1 shows crystallographic atomic parameters of disorder spinel LiMn_{1.5}Ni_{0.5}O₄ cathode phase, derived at 800° C. for 12 h using Rietveld refinement analysis.

TABLE 1

| Atom | Site | x/a | y/b | z/c | Occ. | Uᵢₛₒ |
|---|---|---|---|---|---|---|
| Li1 | 8a | 0.375000 | 0.375000 | 0.375000 | 1.2207 | 0.02449 |
| Mn1 | 16d | 0.000000 | 0.000000 | 0.000000 | 0.7499 | 0.04620 |
| Ni1 | 16d | 0.000000 | 0.000000 | 0.000000 | 0.2500 | 0.00354 |
| O1 | 32e | 0.243350 | 0.243350 | 0.243350 | 0.9807 | 0.02966 |

It can be seen that the experimental powder XRD pattern (asterisk in black) was completely fitted by the calculated XRD pattern (red) with reduced residue in difference (blue) for spinel LiMn_{1.5}Ni_{0.5}O₄ cathode material, as shown in FIG. 2g. The schematic illustrations of the crystal structure for the derived spinel LiMn_{1.5}Ni_{0.5}O₄ cathode material was demonstrated with lithium (purple), manganese/nickel (blue), and oxygen (red) by calculated lattice parameters values using VESTA software, as shown in FIG. 2h. The arrangements of lithium tetrahedra (LiO₄ in purple) and Mn/Ni octahedra (MnO₆/NiO₆ in cyan) indicate disordered phase cubic structure with Fd3̅m space group for spinel LiMn_{1.5}Ni_{0.5}O₄ cathode material, as shown in the FIG. 2h(i). The atomic arrangement of Li, Mn and Ni atoms demonstrated a 3D framework structure represented in ball and stick model, as shown in FIG. 2h(ii). The schematized model is viewed in different orientations of (111), (100) and (110) planes, as depicted in FIG. 2g(iii-vi). In the (111) plane view (FIG. 2h(iii)), the atomic arrangement of Li, Mn, Ni and O atoms are shown as hexagonal patterns. A 3D framework structure is viewed in (100) plane with polyhedra model as shown in FIG. 2h(iv) corresponding to more lithium atoms exposed at (100) surface for fast Li⁺ ion transport kinetics, as indicated with ball and stick model in FIG. 2h(v) and associated with the structure of spinel LiMn_{1.5}Ni_{0.5}O₄ cathode. In the (110) plane view, the edge-sharing MnO₆ and NiO₆ octahedra share corners and form a 3D framework structure with a channel as shown in FIG. 2h(vi). From these, it is confirmed that the schematized structure exactly matched with disordered phase Fd3̅m structure for spinel LiMn_{1.5}Ni_{0.5}O₄ cathode.

Secondary microparticles of the spinel LiMn_{1.5}Ni_{0.5}O₄ cathode were reduced in size by segregation of primary nanoparticles and its surface altered using a polymer layer (PMMA+PVdF) and a conducting network (MWCNT). After surface modification it can be seen from FIG. 2i that there are no significant changes observed in the powder XRD pattern (green) as compared with pristine (blue). Indexing of the diffraction peaks with the standard pattern of ICSD #98-007-0023 (pink), as shown in FIG. 2i, confirming the spinel LiMn_{1.5}Ni_{0.5}O₄ cathode phase (blue) is retained.

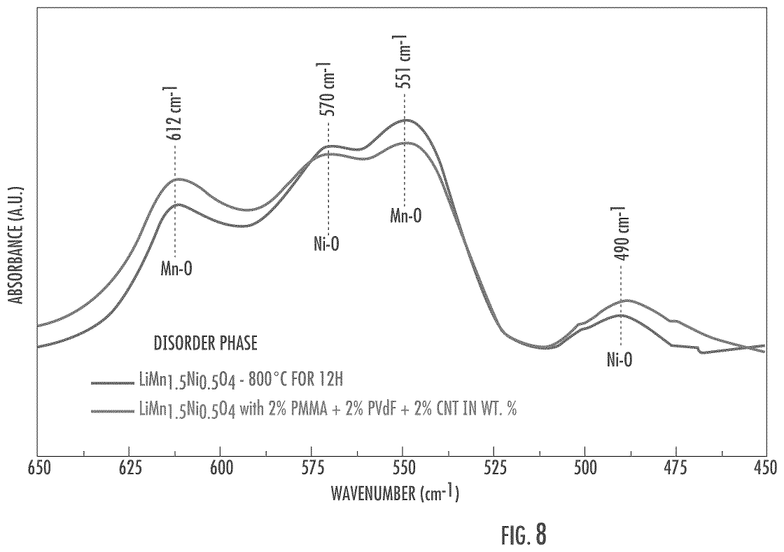

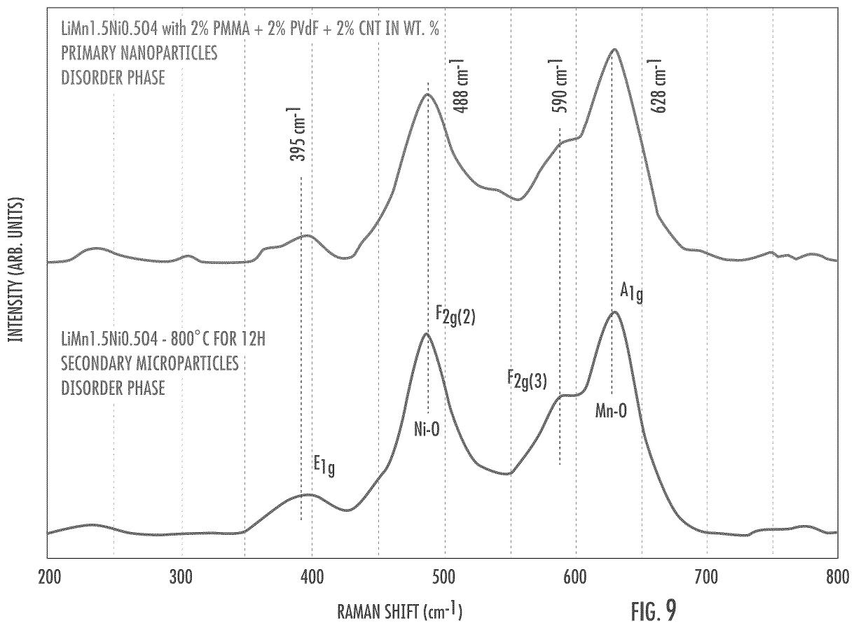

Referring to FIG. 8, Fourier-transform infrared spectroscopic (FT-IR) spectra of spinel LiMn_{1.5}Ni_{0.5}O₄ cathode derived at 800° C. for 12 hours (lower line, blue) and surface modified LiMn_{1.5}Ni_{0.5}O₄ cathode with surface coating-networking architecture (upper line, green) revealed bands at 612 cm⁻¹ for the symmetric Mn—O stretching mode for MnO₆ octahedra and 490 cm⁻¹ for the Ni²⁺—O stretching mode. The bands at 551 cm⁻¹ and 570 cm⁻¹ were obtained for the spinel structure and represented Mn and Ni cation ordering. The intensities of the bands at 612 cm⁻¹, 570 cm⁻¹, 551 cm⁻¹ and 490 cm⁻¹ were much lower and indicated broad band, confirming existence of disordered phase belonging to Fd3̅m structure, compared to the ordered phase showed higher intensities. Ultimately, the disordered phase of secondary microparticles (lower line, blue) and primary nanoparticles (upper line, green) was confirmed by Raman spectra, as shown in FIG. 9. The band at approximately 628 cm⁻¹ was credited to the Mn—O stretching mode of MnO₆ octahedra (A_{1g}), while the bands at 395 cm⁻¹ (E_{g}) and 488 cm⁻¹ (F_{2g}⁽²⁾) were associated with the Ni²⁺—O stretching mode for the disorder phase Fd3̅m structure. Significantly, the band at 590 cm⁻¹ (F_{2g}⁽³⁾) was detected without split for both samples, confirming the spinel compound was constructed with disordered phase having the Fd3̅m structure. From the described structural studies, it can be concluded that the spinel LiMn_{1.5}Ni_{0.5}O₄ cathode developed with an insignificant content of Mn³⁺ and a disordered phase of Fd3̅m type by this method.

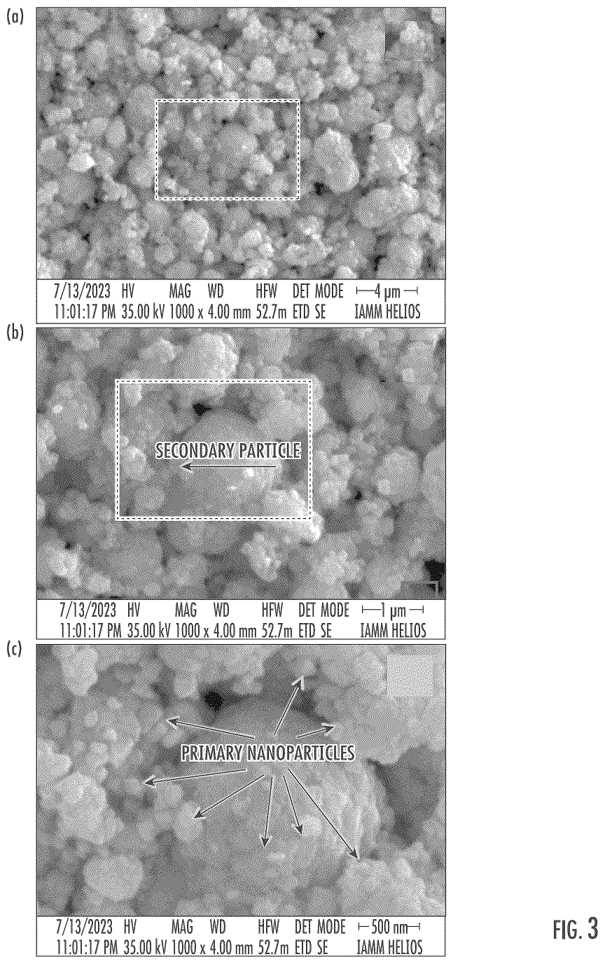

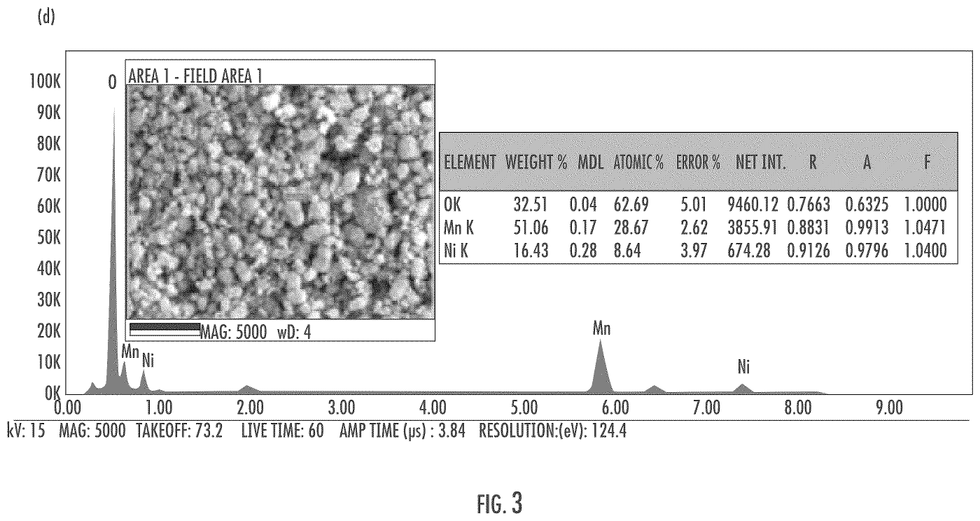

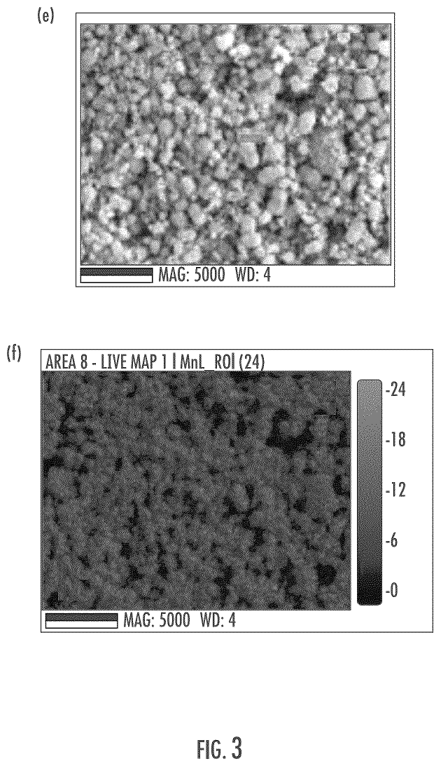

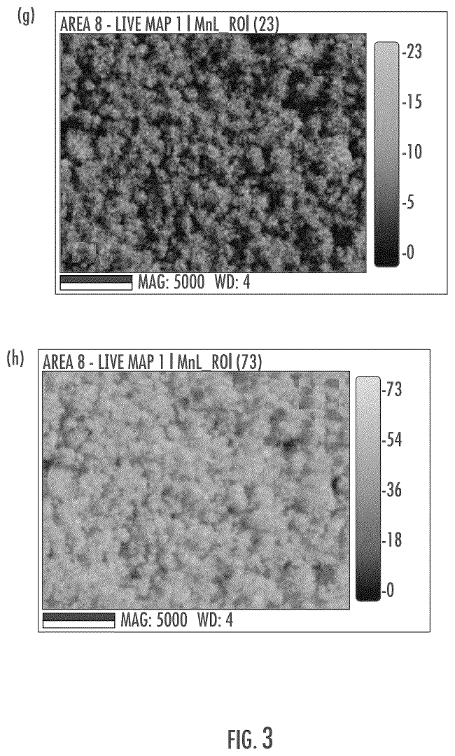

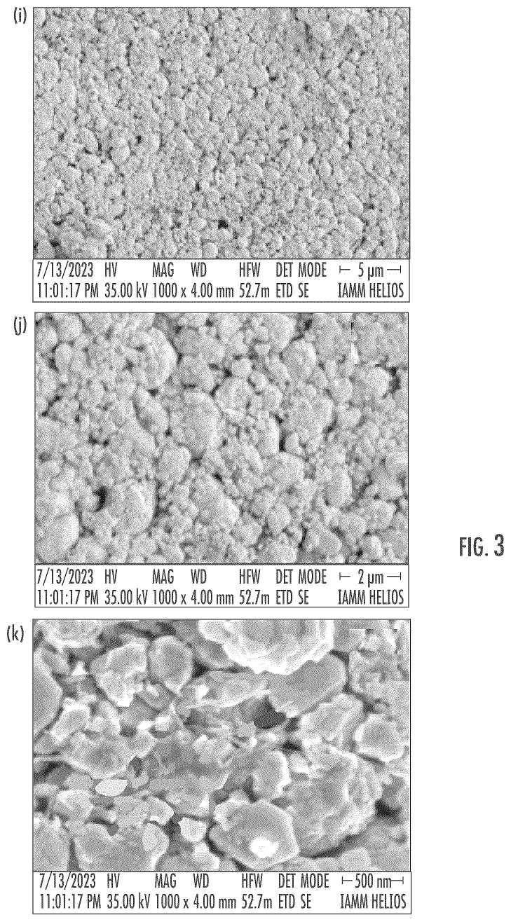

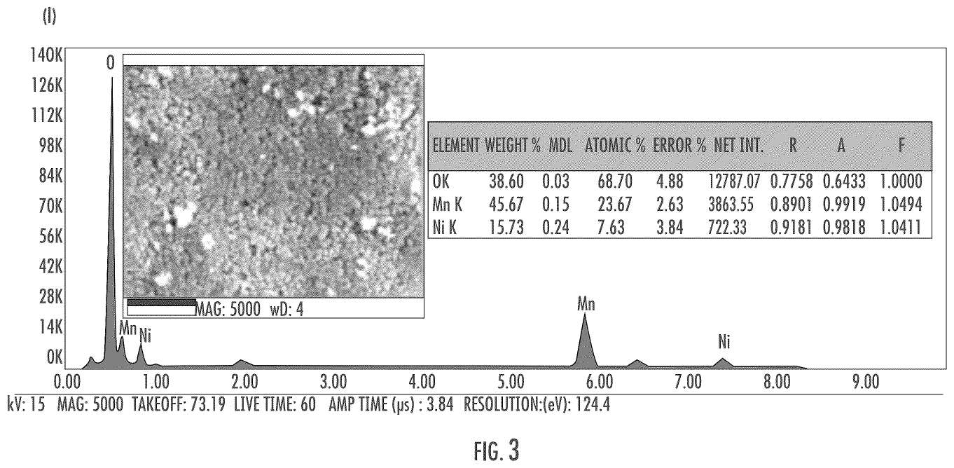

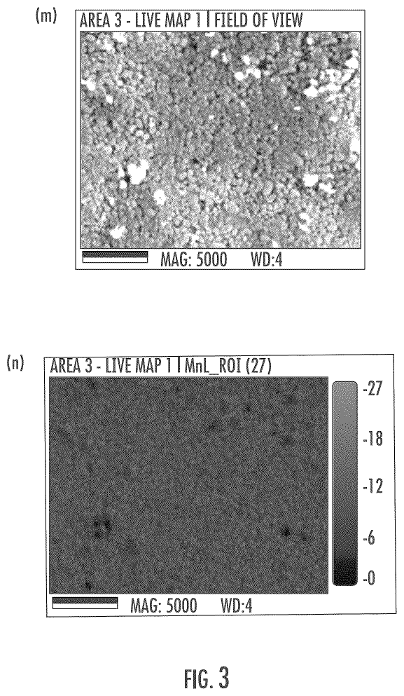

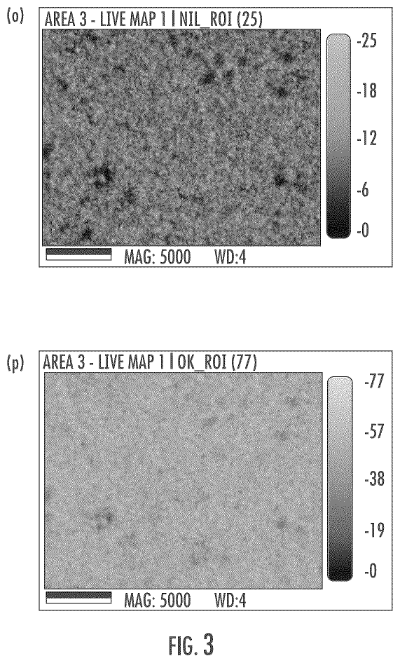

Next, the surface morphological characteristics of the secondary microparticles and primary nanoparticles were investigated. The morphology and particle size of the derived materials were examined using field-emission scanning electron microscopic (FESEM) analyses, as shown in FIG. 3. The FESEM images of the spinel LiMn_{1.5}Ni_{0.5}O₄ cathode derived at 800° C. for 12 hours confirmed a well dispersed spherical shape secondary microparticles morphology with the particle size of ˜1 μm, as indicated in FIG. 3a-b. Secondary microparticle comprised by clustered primary nanoparticles with the particle size of less than 50 nm (FIG. 3c) were produced by releasing toxic free gaseous state products of CO₂ and H₂O during thermal decomposition of the Mn_{1.5}Ni_{0.5}(OH)₂CO₃ precursor with Li₂CO₃ and calcination at 800° C. for 12 hours (per Equation 1). As shown in FIG. 3d, the energy dispersive X-ray (EDX) spectrum of secondary particle images revealed the presence of Mn, Ni and O elements in the spinel LiMn_{1.5}Ni_{0.5}O₄ cathode derived at 800° C. for 12 hours and quantified the atomic percentage of Mn and Ni with ˜3:1 ratio.

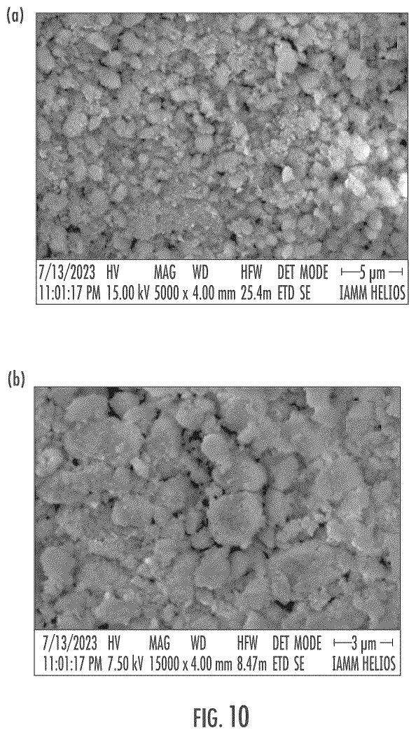

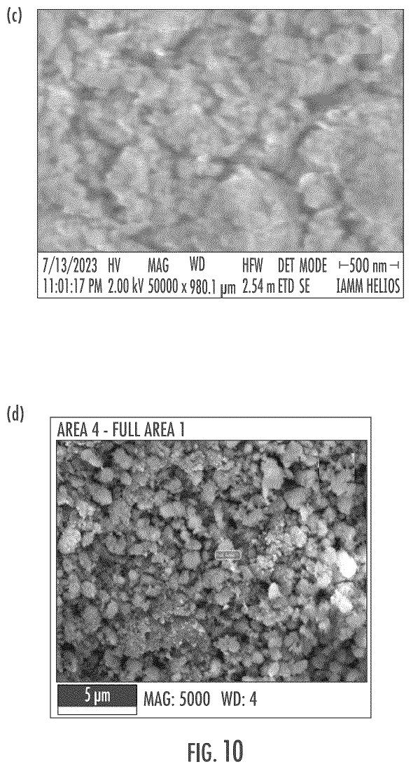

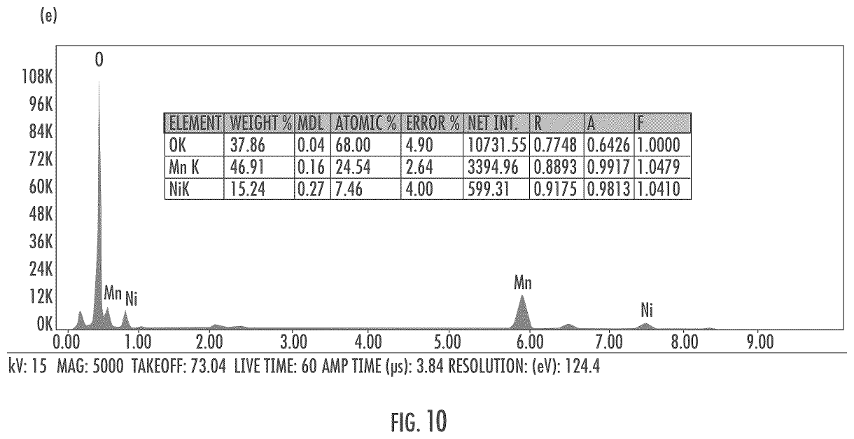

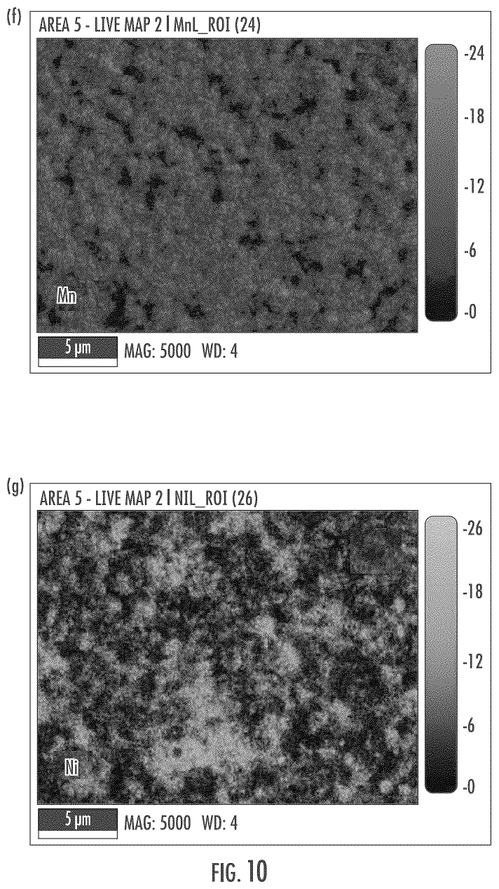

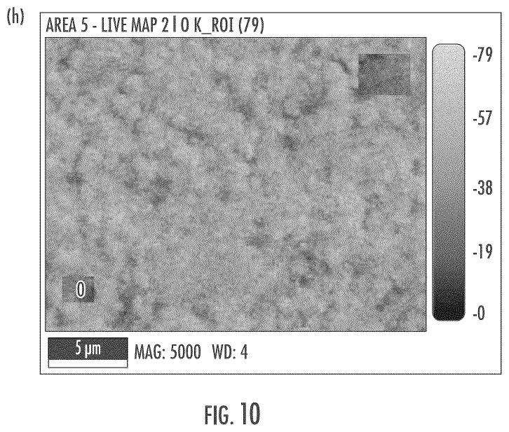

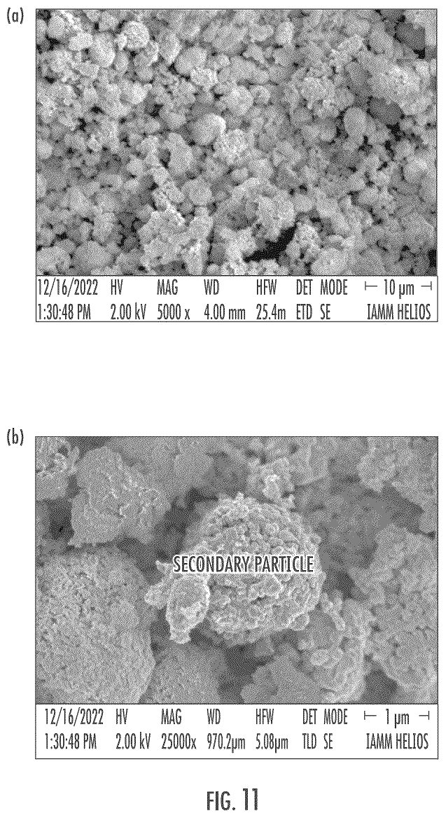

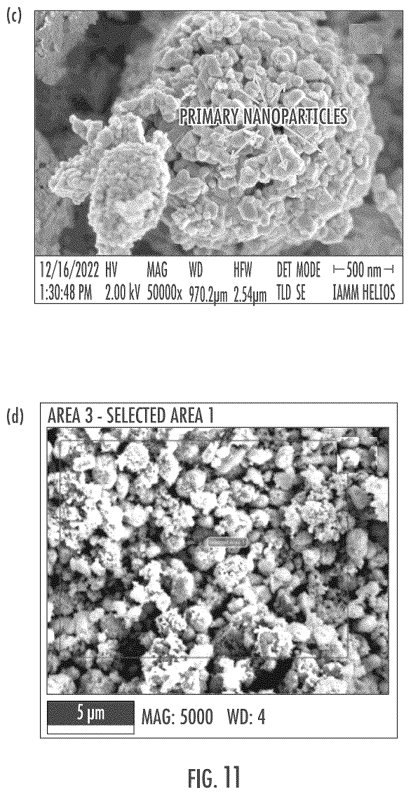

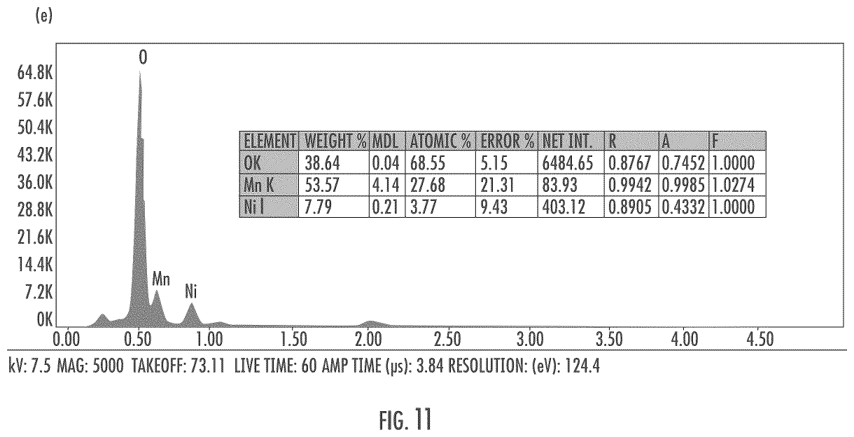

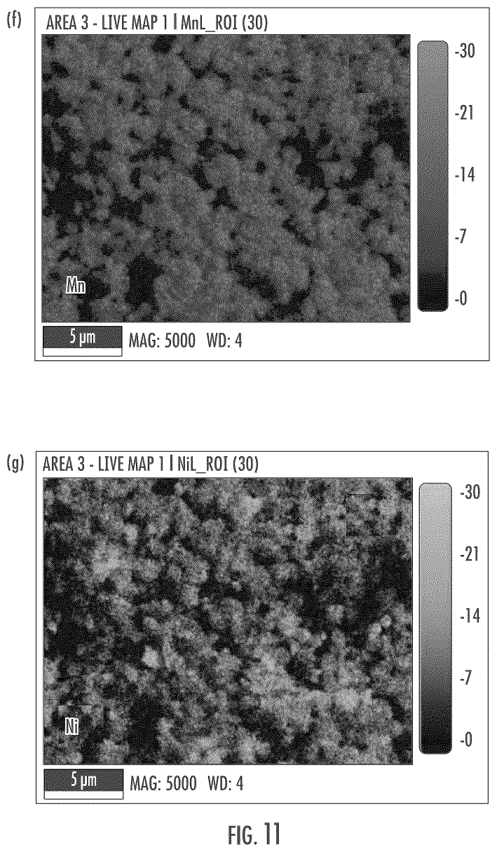

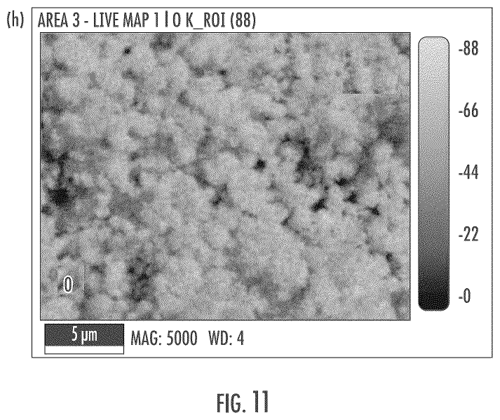

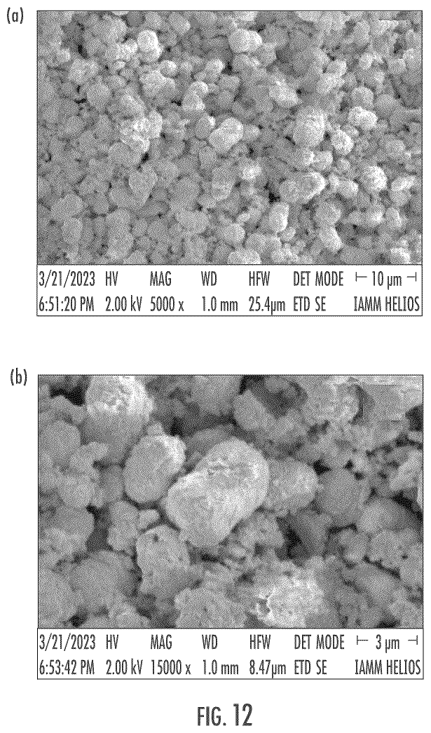

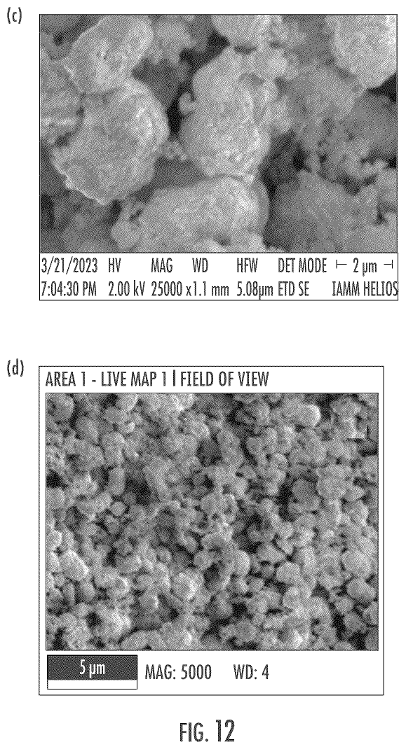

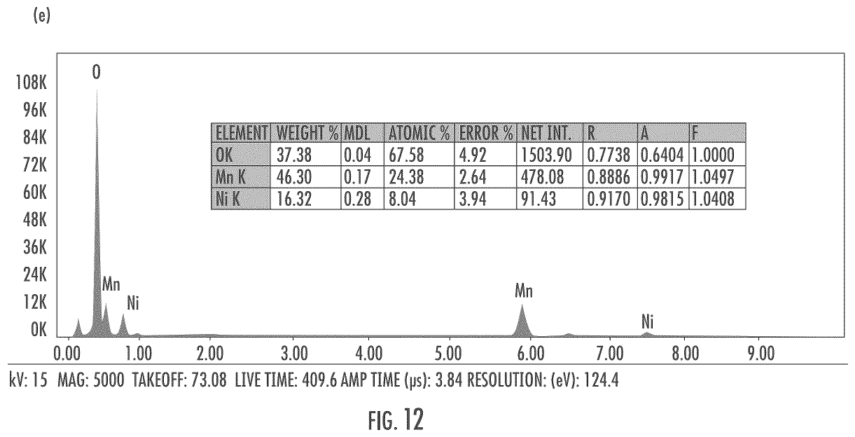

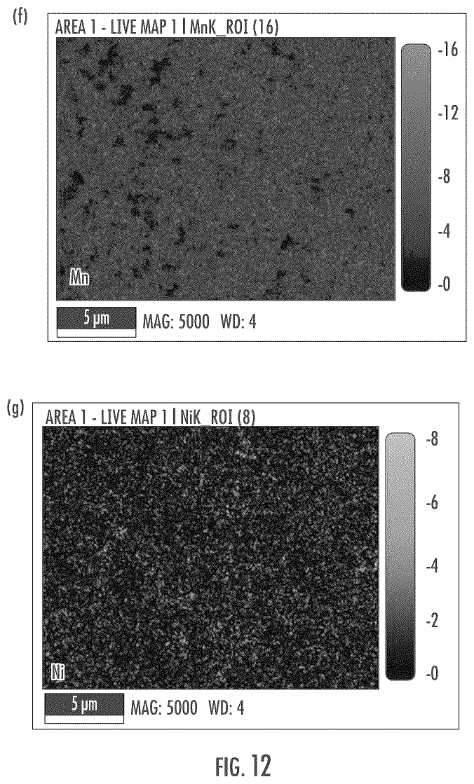

For further confirmation of elemental distribution, simultaneous FESEM elemental mapping analyses were performed (FIG. 3e) and confirmed the presence of Mn (purple, FIG. 3f), Ni (orange, FIG. 3g) and O (green, FIG. 3h) elements. The spherical shape secondary microparticles morphology retained from the Mn_{1.5}Ni_{0.5}(OH)₂CO₃ precursor is shown in FIG. 10. Similar secondary microparticle morphology composed of primary nanoparticles with pores was exhibited for the spinel LiMn_{1.5}Ni_{0.5}O₄ cathode derived at 500° C. for 12 hours (FIG. 11) and 900° C. for 12 hours (FIG. 12). However, electrochemical performance is expected to be less for the sample derived at 500° C. for 12 hours due to less crystallinity. The disorder phase can form at above 750° C., and a rock-salt impurity phase (LiₓNi₁₋ₓO₂) was detected in the sample derived at 900° C. for 12 hours, as shown in the ex-situ XRD results (FIG. 2b-c). Thus, the spinel LiMn_{1.5}Ni_{0.5}O₄ cathode derived at 800° C. for 12 hours exhibited a disordered phase with Fd3̅m structure which contained an insignificant content of Mn³⁺ without rock-salt impurity phase (LiₓNi₁₋ₓO₂), as confirmed in FIG. 2c-f, FIG. 3, FIG. 8 and FIG. 9.

Subsequently, secondary microparticles derived at 800° C. for 12 hours were reduced in size by segregation of primary nanoparticles with a surface coating of PMMA+PVdF polymer layer and a conducting network of MWCNT. As shown in FIG. 3i-j, the primary nanoparticles were segregated and aligned in a uniform pattern with surface smooth morphology compared to secondary microparticles (FIG. 3a-b). Well dispersed primary nanoparticles with a surface smooth morphology (FIG. 3i-j) obtained by pressure built-up of acetone solvent evaporation at 70° C. with vigorous stirring and further heating in an oven at 90° C. and its surface modified using a polymer layer and conducting network of CNT, as indicated in FIG. 3k. The EDX spectrum of the primary nanoparticles showed the presence of Mn, Ni and O elements and quantified the atomic percentage of Mn and Ni with ˜3:1 ratio, as shown in FIG. 3l. Simultaneous FESEM elemental mapping analyses of primary nanoparticles were performed (FIG. 3m) and confirmed the uniform distribution of Mn (purple, FIG. 3n), Ni (orange, FIG. 3o) and O (green, FIG. 3p) elements.

Micro to nano architecture design was confirmed by high-resolution transmission electron microscopic (TEM) analyses of secondary microparticles and primary nanoparticles, as shown in FIG. 4. The secondary microparticles were comprised with primary nanoparticles and packed densely with the particle dimension of ˜1 μm (FIG. 4a-g). It can be clearly seen that the primary nanoparticles were presented with high crystallinity having polyhedra shapes viz., spherical, and hexagonal flakes, as indicated in FIG. 4c-g and the fast Fourier-transform image revealed a hexagonal pattern (FIG. 9h). The selected area electron diffraction pattern (SAED) of the HRTEM image (FIG. 4i) depicted bright diffraction spots indicating high crystallinity, as shown in FIG. 4j. After segregation with surface modification, the HRTEM images exhibited well dispersed primary nanoparticles (˜50 nm in size) with polyhedra shape, connected with CNT (FIG. 4k-o). The surface coating of polymer layer (PMMA+PVdF) on primary nanoparticles was confirmed (FIG. 4p-r) and the SAED pattern of the HRTEM image (FIG. 4s) showed bright diffraction spots indicating high crystalline nature of the particles, as shown in FIG. 4t. The surface coating of PMMA+PVdF polymer layer on primary nanoparticles prevents side reactions between active particles and electrolyte to enhance cathode life at high voltage and the conducting network of CNT increases electronic conductivity of the spinel LiMn_{1.5}Ni_{0.5}O₄ cathode.

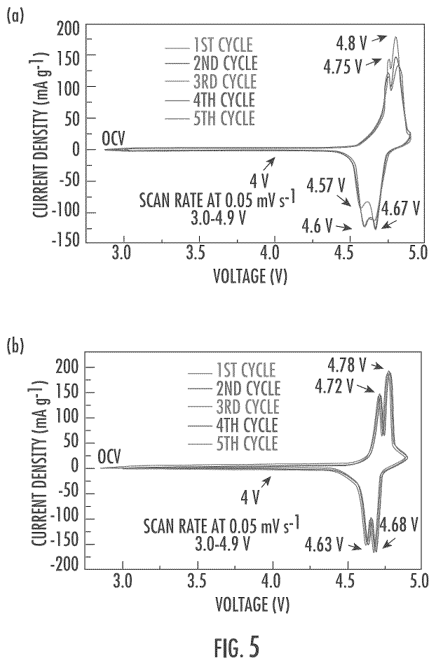

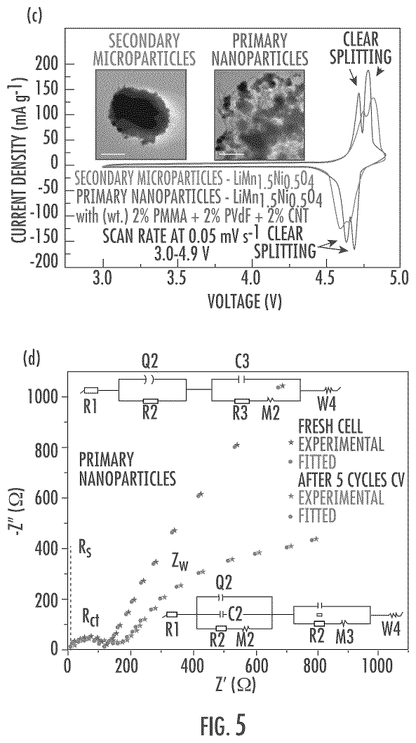

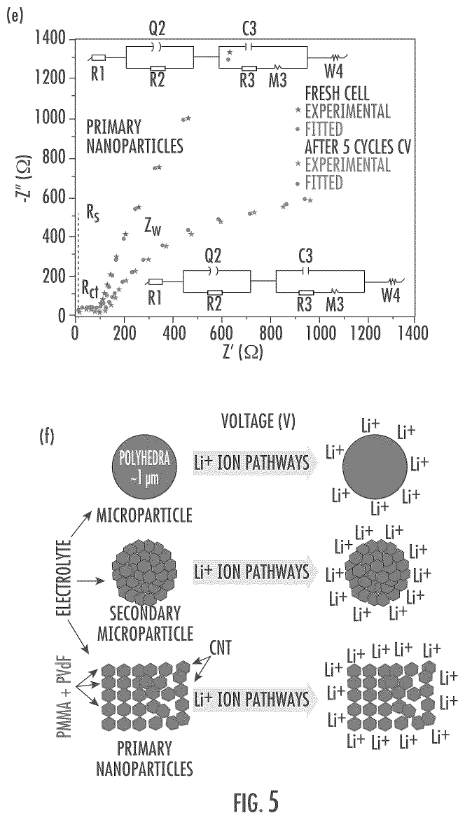

To examine the kinetic reversible characteristics on the material developed, cyclic voltametric (CV) analyses were carried out to fabricated lithium cells of Li versus secondary microparticles and Li versus primary nanoparticles. The fabricated lithium cells were assembled with a mixture solution containing 98% of 1M LiPF₆ in EC+December (1:1 vol %) electrolyte and 2% of fluoroethylene carbonate (FEC) additive, and were tested between 3.0 to 4.9 V at 0.05 mV s⁻¹ for 1-5 cycles, as shown in FIG. 5a-c. During the first cycle, pronounced anodic oxidation peaks occurred at 4.75 V and 4.8 V corresponding to the kinetic oxidation process of Ni²⁺ to Ni³⁺ and Ni³⁺ to Ni⁴⁺, while cathodic reduction peaks occurred at 4.67 V and 4.57 V attributed to the reversible reduction process of Ni⁴⁺ to Ni³⁺ and Ni³⁺ to Ni²⁺ (FIG. 5a) for secondary microparticles. The two well-separated redox peaks at around the 4.7 V region were corroborated with two-stage Li⁺ ion deintercalation and intercalation processes for the spinel LiMn_{1.5}Ni_{0.5}O₄ cathode. The 2^{nd} cycle oxidation peak of Ni²⁺ to Ni³⁺ slightly shifted to the left side (4.74 V) and the reduction peak of Ni³⁺ to Ni²⁺ shifted to the right side (4.6 V), indicating increments in the kinetic reversibility and the CV signals obtained with the same current intensities, peak shapes, and voltage positions for 2 to 5 cycles (FIG. 5a). A very small CV redox peak at the 4 V region appeared for Mn³⁺ to Mn⁴⁺, confirming an insignificant content of Mn³⁺ presented in the disordered phase spinel LiMn_{1.5}Ni_{0.5}O₄ cathode, and good agreement with the obtained XRD results.

The primary nanoparticles showed two oxidation peaks at 4.72 V and 4.78 V with high current intensity, associated with the oxidation process of Ni²⁺ to Ni³⁺ and Ni³⁺ to Ni⁴⁺ and completely reversed during cathodic scan with two reduction peaks occurred at 4.68 V and 4.63 V for the reduction process of Ni⁴⁺ to Ni³⁺ and Ni³⁺ to Ni²⁺, as shown in FIG. 5b. The voltage difference (ΔV) of the observed redox peaks for the secondary microparticles and the primary nanoparticles was ΔV=˜0.03 V. The two well-resolved redox peaks at 4.7 V region are associated with disordered phase spinel LiMn_{1.5}Ni_{0.5}O₄ cathode with Fd3̅m space group. Significantly, the observed CV signal of primary nanoparticles at 4 V for the Mn³⁺ to Mn⁴⁺ redox process almost disappeared, confirming an insignificant content of Mn³⁺ in the derived primary nanoparticles with the disordered phase, as corroborated with the XRD results (FIG. 2i). The primary nanoparticles revealed two redox peaks with clear splitting and high current intensity (blue) compared to the secondary microparticles (red), as shown in FIG. 5c, indicating superior electrochemical performance can be achieved for the primary nanoparticles compared to the secondary microparticles.

For further understanding of Li⁺ ion transport kinetic characteristics, electrochemical impedance spectroscopic (EIS) analyses were performed on secondary microparticles and primary nanoparticles using fabricated lithium cells (Li vs. secondary microparticles and Li vs. primary nanoparticles). Nyquist plots of the fresh cells and after 5 cycles CV for secondary microparticles and primary nanoparticles (asterisks) were obtained and fitted (circles) with equivalent circuit components, as shown in FIG. 5d-e and calculated circuit component values, shown in Table 2.

Table 2 shows experimental and fitted electrochemical impedance characteristics of disordered phase spinel LiMn_{1.5}Ni_{0.5}O₄ cathode, derived at 800° C. for 12 h, (i) Li vs. secondary microparticles before CV test, (ii) Li vs. secondary microparticles after CV test for 1-5 cycles, (iii) Li vs. primary nanoparticles before CV test and (iv) Li vs. primary nanoparticles after CV test for 1-5 cycles, assembled with secondary microparticles/primary nanoparticles cathode, lithium metal foil, Celgard polypropylene separator and a mixture solution containing 98% of 1M LiPF₆ in EC+December (1:1 vol %) electrolyte and 2% of fluoroethylene carbonate (FEC) additive.

TABLE 2

| | | Impedance components | | |
|---|---|---|---|---|
| | | R in ohms, C in farad and | Phase element | |
| S. No | Cell | Q in coulombs | (Φ) | Remarks |
| (i) | Li/LiMn_{1.5}Ni_{0.5}O₄ | R₁ = 1.6, R₂ = 121.5, | a₂ = 0.715 | Less Li⁺ ion diffusion pathways - Higher Li⁺ ion |
| | Secondary microparticles | R₃ = 14.69 | td₃ = 1540 | diffusion length - Fitted with equivalent circuit |
| | Fresh cell | Rd₃ = 22705 | s₄ = 64.81 | components - Revealed charge transfer |
| | | Q₂ = 25.9 × 10⁻⁶ | | resistance - Li⁺ ion intercalation and |
| | | C₃ = 4.341 × 10⁻³ | | deintercalation. |
| (ii) | Li/LiMn_{1.5}Ni_{0.5}O₄ | R₁ = 3.1, R₂ = 150.6, | a₂ = 0.7368 | Nyquist plot fitted with complex equivalent |
| | Secondary microparticles | R₃ = 242.4, Rd₂ = 1633 | td₂ = 62.63 | circuit components - Increased charge transfer |
| | After 5 cycles CV | Rd₃ = −82.21 | td₃ = - 14.65 | resistance - Corresponding to an additional |
| | | Q₂ = 18.71 × 10⁻⁶ | s₄ = 7.052 | charge storage buildup - High semi-infinite |
| | | C₂ = −0.1686 × 10⁻⁶ | | linear diffusion. |
| | | C₃ = 0.01172 | | |
| (iii) | Li/LiMn_{1.5}Ni_{0.5}O₄ | R₁ = 1.17, R₂ = 83.45, | a₂ = 0.8365 | Increased Li⁺ ion pathways - Decreased Li⁺ ion |
| | Primary nanoparticles | R₃ = 3178 | td₃ = −0.02433 | diffusion length - Nyquist plot fitted with |
| | Fresh cell | Rd₃ = 4.237 | s₄ = 67.47 | complex equivalent circuit components - Less |
| | | Q₂ = 8.572 × 10⁻⁶ | | charge transfer resistance - Limits an electrode |
| | | C₃ = 5.608 × 10⁻³ | | charge transfer resistance build-up - High semi- |
| | | | | infinite linear diffusion. |
| (iv) | Li/LiMn_{1.5}Ni_{0.5}O₄ | R₁ = 2.1, R₂ = 97.1, | a₂ = 0.7114 | Nyquist plot almost overlapped and fitted with |
| | Primary nanoparticles | R₃ = 479.3 | td₃ = −1.89 × 10⁻⁶ | complex equivalent circuit components - |
| | After 5 cycles CV | Rd₃ = 16762 | s₄ = 151.2 | Analogous charge transfer resistance - High |
| | | Q₂ = 19.54 × 10⁻⁶ | | semi-infinite linear diffusion. |
| | | C₃ = 4.809 × 10⁻³ | | |

Referring to FIG. 5d, the Nyquist plot of secondary microparticles in the fresh cell (blue-asterisks) showed a semicircle with the charge transfer resistance of R_{ct}˜123Ω (R₂=121.5Ω) at high-frequency and fitted (red) with an equivalent circuit of R₁+Q₂/R₂+C₃/(R₃+M₃)+W₄. After 5 cycles CV, the EIS spectrum of secondary microparticles (pink) depicted a similar Nyquist plot with increased charge transfer resistance R_{ct}˜159Ω (calculated R₂=150.6Ω) and fitted (cyan) with an equivalent circuit of R₁+Q₂/C₂/(R₂+M₂)+C₃/(R₃+M₃)+W₄ having additional circuit components of capacitance C₂ and restricted diffusion M₂ (Rd₂). The observed increment in the charge transfer resistance is associated with the formation of thicker cathodic-electrolyte-interface (CEI) film during an initial anodic scan and subsequent internal side reactions between secondary microparticles and electrolytes during cycles, as corroborated with the literature reports.

On the other hand, referring to FIG. 5e, Nyquist plots of primary nanoparticles before and after 5 cycles CV were almost overlapped and showed less charge transfer resistance of R_{ct}˜91Ω (blue, FIG. 5e) and R_{ct}˜102Ω (pink, FIG. 5e) than secondary microparticles R_{ct}˜123Ω for fresh cell (blue, FIG. 5d) and R_{ct}˜159Ω for after 5 cycles CV (pink, FIG. 5d). The lower charge transfer resistance r_{ct}˜91Ω of fresh cell for primary nanoparticles is attributed to multiple Li⁺ ion pathways and decreased Li⁺ ion diffusion length of primary nanoparticles than the secondary microparticles, as confirmed from the two well-resolved redox peaks of primary nanoparticles in FIG. 5b-c. Also, the reduced charge transfer resistance R_{ct}˜102Ω of primary nanoparticles after 5 cycles CV is correlated with the formation of a thin CEI film on a surface smoothness of well-aligned nanoparticles, preventing subsequent internal side reactions between nanoparticles and electrolyte during cycles, as shown by the steady-state CV curves in FIG. 5b-c.

The impedance of the electrode comprised of primary nanoparticles is increased after aging, indicating more reactivity than microparticles, and losses in the active mass revealed increased electrode impedance. It is remarkable that after CV studies the charge transfer resistance build-up in segregated primary nanoparticles is controlled by the surface-coating of PMMA+PVdF polymer layer and conducting-network of CNT. It is pertinent that the entire EIS spectra of primary nanoparticles were fitted (red for fresh cell and cyan for after 5 cycle CV in FIG. 5e) with an analogous equivalent circuit of R₁+Q₂/R₂+C₃/(R₃+M₃)+W₄ and a calculated resistance R₂=83.45Ω for fresh cell (red) and R₂=97.1Ω after 5 cycle CV (cyan), indicated close matching with the observed charge transfer resistance R_{ct}˜91Ω (blue) and R_{ct}˜102Ω (pink). The Nyquist plots are also composed with an electrolyte solution resistance of Rₛ=1.6/3.1Ω for secondary microparticles and Rₛ=1.1/2.1Ω for primary nanoparticles at high-frequency, and a slanting Warburg line Z_{w} (combination of C₃, R₃, M₃, Rd₂ and Rd₃) at low-frequency for high semi-infinite linear diffusion process associated with secondary microparticles and primary nanoparticles of disordered phase spinel LiMn_{1.5}Ni_{0.5}O₄ cathode.

The high reversibility and enhanced Li⁺ ion transport kinetics are described with schematic illustrations of particle shape, as shown in FIG. 5f. Notably, microparticles with polyhedra shape (spherical, cubic, hexagonal, etc.,) undergo limited Li⁺ ion transport due to less Li⁺ ion diffusion pathways and higher Li⁺ ion diffusion length, which promote results of side reactions between electrolyte and active material and charge transfer resistance build up in the overall electrode impedance (FIG. 5f). However, secondary microparticles exhibited increased Li⁺ ion transport by accepting more Li⁺ ions through the pore and surface of primary nanoparticles, enabling increased Li⁺ ion diffusion pathways, decreased Li⁺ ion diffusion length and reduced side reactions, as shown in FIG. 5f. The secondary microparticles cannot sustain high Li⁺ ion transport without causing unwanted side reactions between electrolyte and active material, limiting high-voltage cathode life at high-rate. On the contrary, the segregated primary nanoparticles with surface-coatings of PMMA+PVdF polymer layer and conducting network of CNT are highly crystalline and exhibit fast Li⁺ ion transport due to multiple Li⁺ ion diffusion pathways and shorter Li⁺ ion diffusion length, which should limit side reactions between electrolyte and active material. This limits the electrode charge transfer resistance build-up at high-rate, and enhances the kinetic characteristics of redox process Ni²⁺ to Ni³⁺ and Ni³⁺ to Ni⁴⁺, resulting in well-resolved redox peaks. The Li⁺ ion reversible and transport kinetic studies confirmed that the developed cathode can potentially achieve high voltage, high rate and high durability.

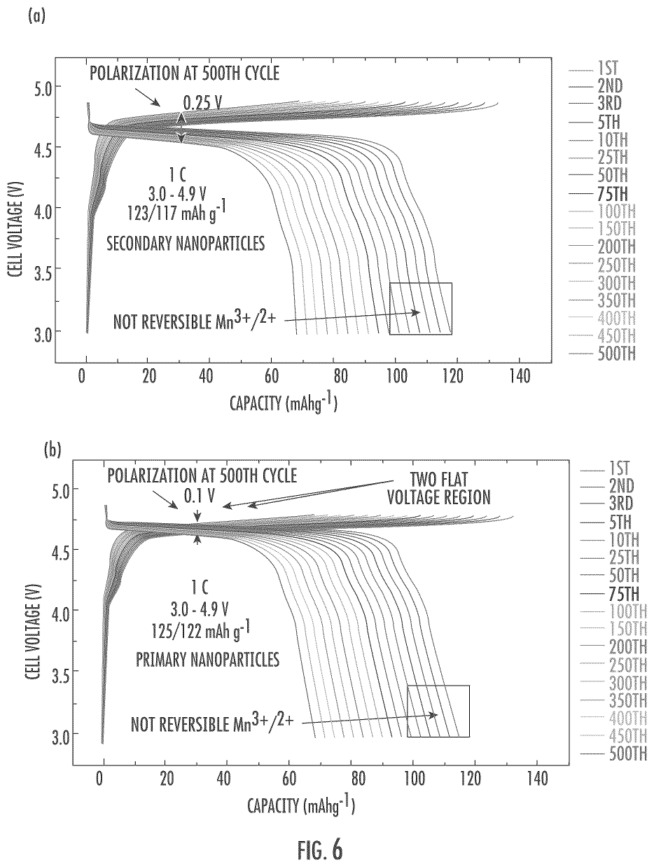

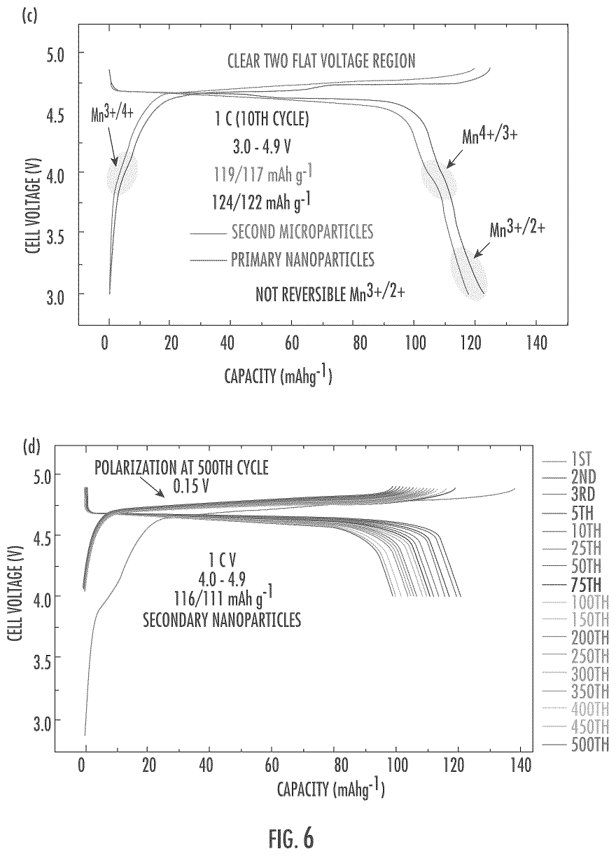

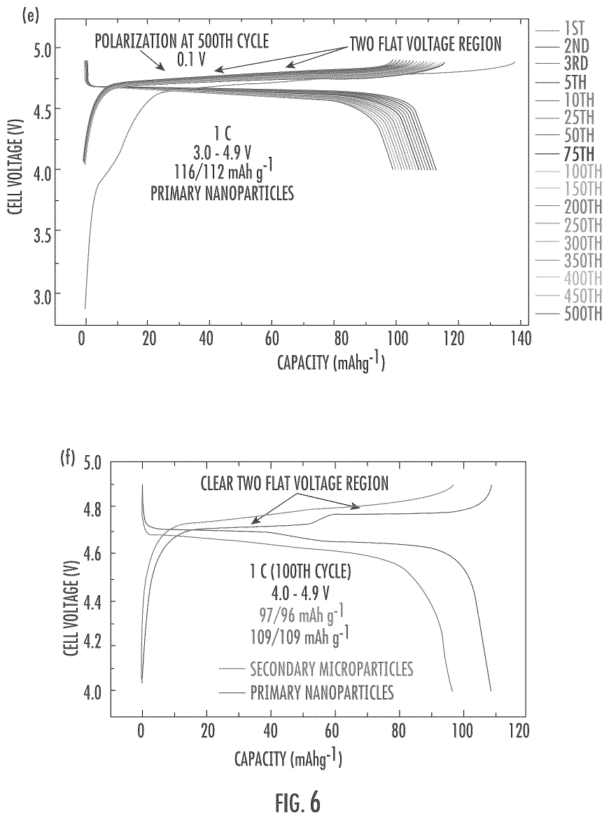

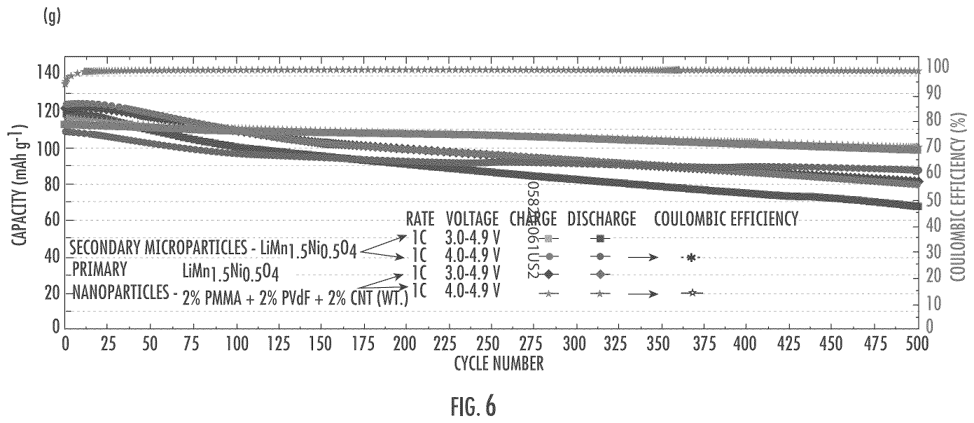

It was discovered that the primary nanoparticles with the surface-coated networking architecture enable a stable flat voltage profile. Galvanostatic charge and discharge cycling studies were investigated between 3.0-4.9 V and 4.0-4.9 V at 1 C for fabricated lithium cells, assembled with either the secondary microparticles or primary nanoparticles of disordered phase spinel LiMn_{1.5}Ni_{0.5}O₄ cathode having lithium metal anode and a mixture solution containing 98% of 1M LiPF₆ in EC+December (1:1 vol %) electrolyte and 2% of FEC additive, as shown in FIG. 6. The voltage vs. capacity profiles (FIG. 6a) of secondary microparticles derived at 800° C. for 12 hours depicted a flat voltage plateau at 4.7 V and delivered the reversible charge-discharge capacity of 123/117 mAh g⁻¹, while segregated primary nanoparticles revealed two clear flat voltage regions at 4.7 V corresponding to the kinetic reversible process of Ni²⁺ to Ni³⁺ and Ni³⁺ to Ni⁴⁺ and delivered the reversible charge-discharge capacity of 125/122 mAh g⁻¹ between 3.0-4.9 V at 1 C (FIG. 6b). The flat voltage profile at 4.7 V was associated with the CV studies for the disordered phase spinel LiMn_{1.5}Ni_{0.5}O₄ cathode.

Segregated primary nanoparticles delivered a discharge capacity of 122 mAh g⁻¹ at the 10^{th} cycle with clear two flat voltage region depicting less polarization in the voltage plateau. In contrast, secondary microparticles delivered the discharge capacity of 117 mAh g⁻¹ at the 10^{th} cycle with a flat voltage profile having high polarization, as shown in FIG. 6c. The voltage hump at 4 V occurred for the reversible redox process of Mn³⁺ to Mn⁴⁺ for secondary microparticles, reflecting an insignificant content of Mn³⁺ in the disordered phase spinel LiMn_{1.5}Ni_{0.5}O₄ cathode, while it almost disappeared in the primary nanoparticles at 10^{th} cycle (as shown in yellow region, FIG. 6c). After the 2^{nd} cycle, an additional voltage mount appeared at 3.25 V and significantly increased up to 50^{th} cycle, related to Mn³⁺ to Mn²⁺ reduction and Jahn-Teller distortion with the capacity contribution of ˜10 mAh g⁻¹, as denoted with yellow regions in FIG. 6a-c. In the electrode, the Mn²⁺ ions generated during discharge are not completely reversible for subsequent charge, however it is highly reactive with an electrolyte for side reactions, causes Mn²⁺ dissolution and losses in the active mass resulting an increased electrode impedance, high polarization, and capacity fade during cycles.

Thus, voltage vs. capacity profiles of secondary microparticles displayed a polarization of about 0.25 V difference between charge and discharge profiles at 500^{th} cycle (denoted at 30 mAh g⁻¹ in x-axis) and delivered the reversible capacity of 67 mAh g⁻¹ (FIG. 6a). On the other hand, the segregated primary nanoparticles demonstrated 50% less polarization of about 0.1 V difference between charge and discharge profiles at 500^{th} cycle (denoted at 30 mAh g⁻¹ in x-axis) and delivered high reversible capacity of 80 mAh g⁻¹ (FIG. 6b). The observed 50% less polarization (0.1 V) and high reversible capacity (80 mAh g⁻¹) of primary nanoparticles compared to secondary microparticles (0.25 V, 67 mAh g⁻¹) at the 500^{th} cycle is associated with the factors of multiple Li⁺ ion diffusion pathways, less Li⁺ ion diffusion length, prevention of internal side reactions between electrolyte and active material by surface-coating of PMMA+PVdF polymer layer, and the conducting network of CNT.

To examine capacity fade, charge-discharge cycling studies were performed at high-voltage range between 4.0-4.9 V at 1 C for fabricated lithium cells of secondary microparticles and primary nanoparticles (FIG. 6d-f), where limited the discharge cut off voltage at 4 V to prevent Mn³⁺ dissolution and Jahn-Teller distortion effects. As shown in FIG. 6d-e, the secondary microparticles and primary nanoparticles showed similar flat voltage profiles and delivered the charge-discharge capacity of 116/111 mAh g⁻¹ and 116/112 mAh g⁻¹ for 2^{nd} cycle at 1 C, which is almost close to the delivered reversible capacity of 117 mAh g ⁻¹ for secondary microparticles and 122 mAh g⁻¹ for primary nanoparticles related to wide voltage range between 3.0-4.9 V (FIG. 6a-b). At the 100^{th} cycle, the primary nanoparticles depicted two flat voltage plateaus at 4.7 V (blue, FIG. 6f) associated with two electron transfer reactions belong to Ni²⁺ to Ni³⁺ and Ni³⁺ to Ni⁴⁺ redox process, reflecting a disordered phase spinel LiMn_{1.5}Ni_{0.5}O₄ cathode, and delivered a higher reversible capacity of 109 mAh g⁻¹ than the secondary microparticles, which delivered a discharge capacity of 96 mAh g⁻¹ corresponding to single flat voltage profile (red, FIG. 6f).

Referring to FIGS. 6d-e, no significant change was observed in the voltage profiles between 1-500 cycles, with reduced polarization of 0.15 V difference (0.25 V for 3.0-4.9 V) for secondary microparticles and 0.1 V difference (analogous to 3.0-4.9 V) for primary nanoparticles between charge and discharge profiles, at 30 mAh g⁻¹ in the x-axis. Moreover, the measured reversible discharge capacity of 86 mAh g⁻¹ for secondary microparticles (67 mAh g⁻¹ for 3.0-4.9 V) and 100 mAh g⁻¹ for primary nanoparticles (80 mAh g⁻¹ for 3.0-4.9 V) at the 500^{th} cycle was almost 20% higher than the wide voltage range between 3.0-4.9 V. The clear two flat voltage plateaus of 100^{th} cycle charge at 1 C for primary nanoparticles indicated the completion of charge step at constant current (CC) mode in this method, however the charge step was unfinished at 1 C and proceeded with an additional constant voltage (CV) mode for the secondary microparticles.

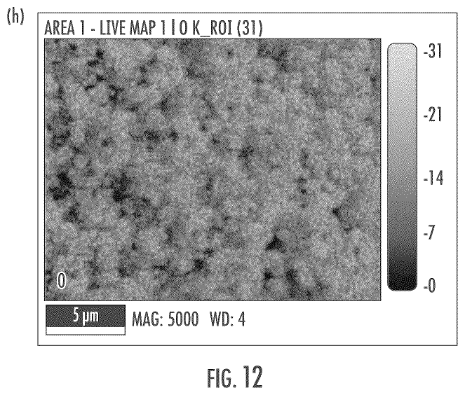

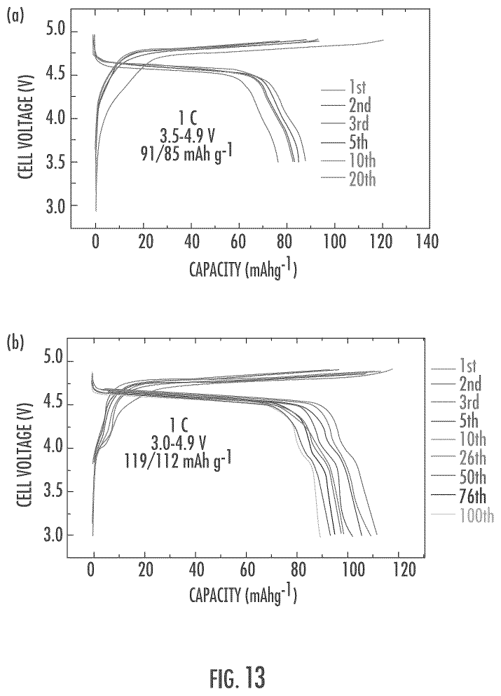

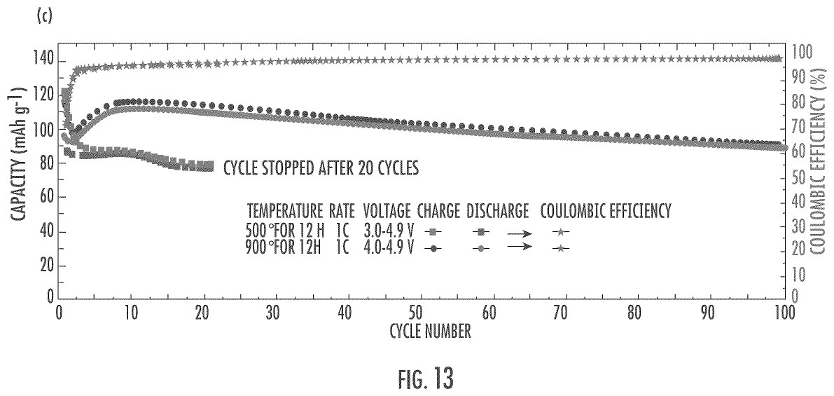

The Galvanostatic charge-discharge cycling studies for secondary microparticles and primary nanoparticles of disordered phase spinel LiMn_{1.5}Ni_{0.5}O₄ cathode derived at 800° C. for 12 hours were compared between wide voltage range (3.0-4.9 V) and high voltage range (4.0-4.9 V) at 1 C for 1-500 cycles, as shown in FIG. 6g. The secondary microparticles and primary nanoparticles delivered a reversible capacity of 117/122 mAh g⁻¹ at 10^{th} cycle and 67/80 mAh g⁻¹ at 500^{th} cycle between 3.0-4.9 V and 109/112 mAh g⁻¹ at 10^{th} cycle and 87/100 mAh g⁻¹ at 500^{th} cycle between 4.0-4.9 V (FIG. 6g) with a coulombic efficiency of ˜99.6% during cycles. The reversible capacity of secondary microparticles derived at 800° C. for 12 hours was higher than for samples derived at 500° C. for 12 hours and 900° C. for 12 hours, delivering reversible capacity of 85 mAh g⁻¹ and 111 mAh g⁻¹ for the 2^{nd} cycle and 76 mAh g⁻¹ and 109 mAh g⁻¹ for the 20^{th} cycle at 1 C with high polarization and capacity loss, as shown in FIG. 13. The obtained poor cycling performance of samples derived at 500° C. for 12 hours and 900° C. for 12 hours can be attributed to less crystallinity and the rock-salt impurity phase LiₓNi₁₋ₓO₂ formation, as corroborated with the XRD results (FIG. 2). Significantly, segregated primary nanoparticles exhibited higher capacity retention of 65% (3.0-4.9 V) and 89% (4.0-4.9 V) than the secondary nanoparticles 57% (3.0-4.9 V) and 80% (4.0-4.9 V) at 500^{th} cycle, due to the multiple Li⁺ ion diffusion pathways and less Li⁺ ion diffusion length of primary nanoparticles, preventing side reactions by surface-coating of PMMA+PVdF, and the conducting network of CNT. Therefore, the obtained high-capacity retention of 89% at the 500^{th} cycle for primary nanoparticles indicates less capacity fade during cycles by suppression of Mn³⁺ dissolution and Jahn-Teller distortion⁶³ between 4.0-4.9 V (FIG. 6g).

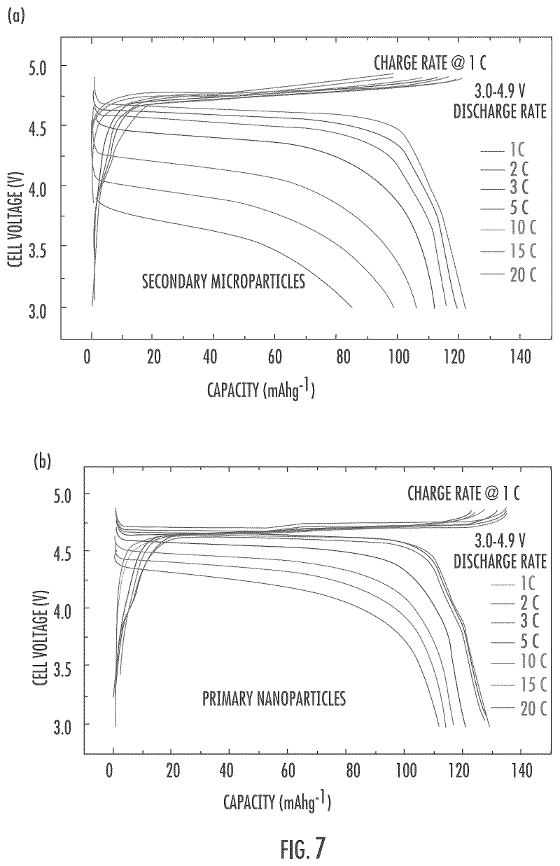

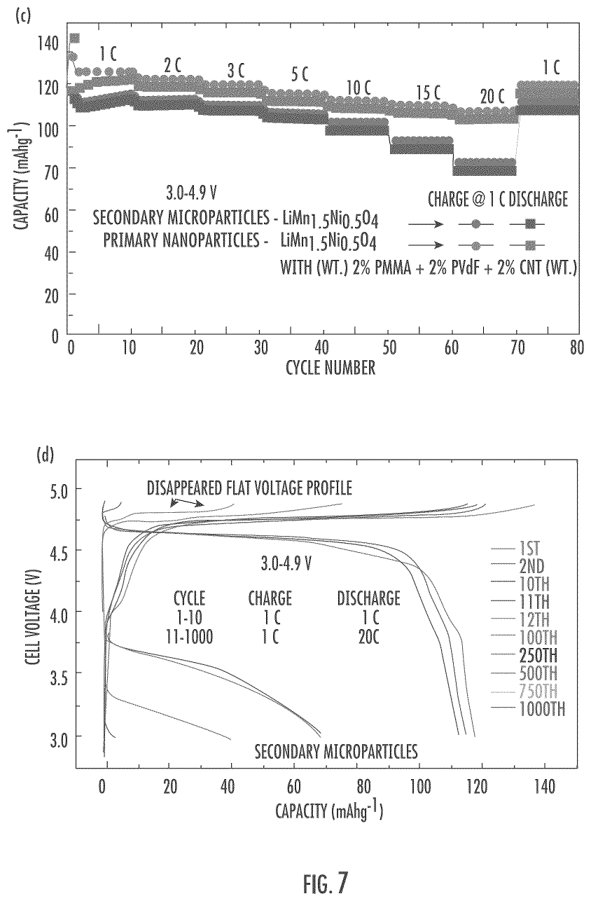

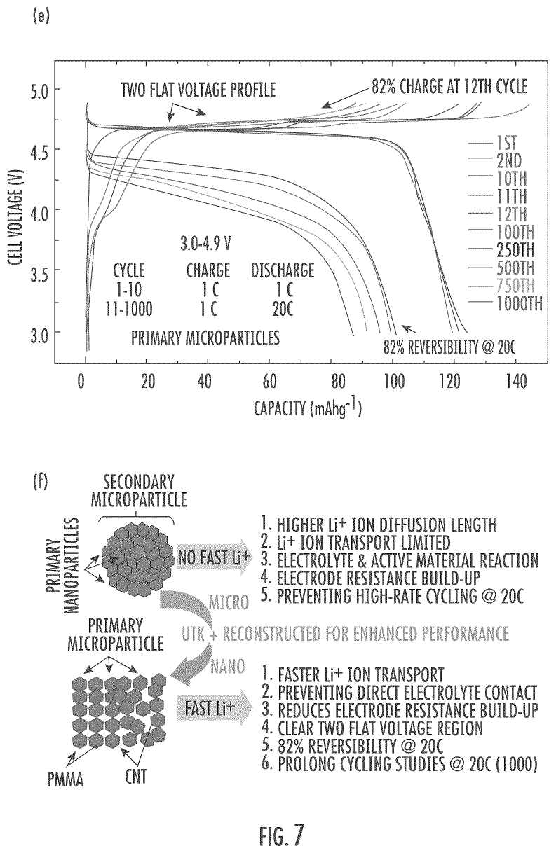

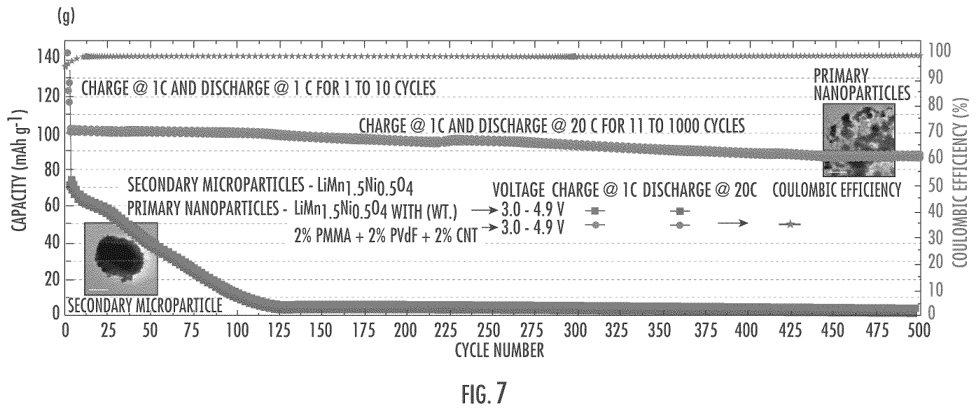

It was discovered that the segregated primary nanoparticles demonstrate stable high voltage cathode life at a high rate discharge. From the charge-discharge cycling results, rate studies were investigated for secondary microparticles and primary nanoparticles using fabricated lithium cells at 1 C charge and discharge at 1 C, 2 C, 3 C, 5 C, 10 C, 15 C and 20 C for 1-80 cycles between 3.0-4.9 V, as shown in FIG. 7. There were no significant changes observed in the discharge flat voltage profiles at different rates. The discharge capacities were 112 mAh g⁻¹ (1 C), 110 mAh g⁻¹ (2 C), 107 mAh g⁻¹ (3 C), 103 mAh g⁻¹ (5 C), 99 mAh g⁻¹ (10 C), 90 mAh g⁻¹ (15 C) and 78 mAh g⁻¹ (20 C) for secondary microparticles (FIG. 7a). On the other hand, the segregated primary nanoparticles delivered two flat voltage regions for 1 C to 3 C and a single flat voltage plateau for 5 C to 20 C with discharge capacities of 120 mAh g⁻¹ (1 C), 119 mAh g⁻¹ (2 C), 116 mAh g⁻¹ (3 C), 112 mAh g⁻¹ (5 C), 108 mAh g⁻¹ (10 C), 106 mAh g⁻¹ (15 C) and 103 mAh g⁻¹ (20 C), as shown in FIG. 7b.

Importantly, at 20 C the segregated primary nanoparticles showed a flat voltage plateau at 4.3 V with less polarization and delivered high reversible capacity of 103 mAh g⁻¹ (FIG. 7b), while secondary microparticles had a much lower voltage plateau at 3.6 V with high polarization and delivered less reversible capacity of 78 mAh g⁻¹ (FIG. 7a). Capacity decay in extended rate cycling performance was significantly less for primary nanoparticles than secondary microparticles for 1-80 cycles at different discharge rates (1 C, 2 C, 3 C, 5 C, 10 C, 15 C and 20 C), as depicted in FIG. 7c. The stable rate cycling performance was achieved for 10 cycles at different discharge rates for primary nanoparticles in comparison with secondary microparticles. Particularly, at 20 C discharge, the charge-discharge capacities between 60-70 cycles were quite stable for primary nanoparticles, while secondary microparticles showed inconsistent cycle stability and drastic capacity decay. However, after high-current discharge at 20 C the secondary microparticles retained almost entire reversible capacity at 1 C comparable to primary nanoparticles between 70-80 cycles (FIG. 7c).

To determine high voltage cathode life at high rates, the rate study of secondary microparticles and primary nanoparticles was extended to a prolonged charge-discharge high rate cycling studies. The test proceeded with initial stabilization cycles at 1 C charge and 1 C discharge for 1-10 cycles and then high-rate cycles at 1 C charge and 20 C discharge for 11-1000 cycles between 3.0-4.9 V, as shown in FIG. 7d-g. Initial stabilization cycles of secondary microparticles at 1 C indicated a similar flat voltage profile and delivered charge-discharge capacities of 121/115 mAh g⁻¹ for the 2^{nd} cycle and 115/113 mAh g⁻¹ for the 10^{th} cycle (FIG. 7d). The subsequent 11^{th} cycle charge step yielded 117 mAh g⁻¹ and delivered a 38% decreased discharge capacity of 70 mAh g⁻¹ at 20 C. Hence, the 12^{th} cycle charge step delivered limited discharge capacities of 75 mAh g⁻¹ at 1 C and 69 mAh g⁻¹ at 20 C. The cell delivered reversible capacity of 40 mAh g⁻¹ at the 100^{th} cycle and vanished the flat plateau at >4 V for the 250^{th} cycle, indicating further cycling decline (FIG. 7d), due to large dimension of secondary microparticles indicating low-rate performance.

In contrast, segregated primary nanoparticles delivered charge-discharge capacities of 127/120 mAh g⁻¹ for the 2^{nd} cycle and 126/122 mAh g⁻¹ for the 10^{th} cycle at 1 C (FIG. 7e) with two flat voltage profiles. Significantly, at 20 C, a discharge capacity of 100 mAh g⁻¹ was obtained for the 11^{th} cycle with a capacity retention of 82%, which was reversible. For a 12^{th} cycle charge at 1 C and discharge at 20 C, the primary nanoparticles delivered charge-discharge capacity of 102/100 mAh g⁻¹ with two flat voltage regions and a flat voltage profile at 20 C. It is important to note that there is no large change seen in the flat voltage profiles of the 100^{th}, 250^{th}, 500^{th}, 750^{th} and 1000^{th} cycles, and delivered reversible discharge capacity of 86 mAh g⁻¹ at 1000^{th} cycle with 70% capacity retention, as shown in FIG. 7d. The remarkable voltage stability and the discharge capacity of 86 mAh g⁻¹ at 1000^{th} cycle corroborated with the Li⁺ ion kinetics studies (FIG. 5) of segregated primary nanoparticles. On the other hand, the charge-discharge voltage profiles of secondary microparticles declined at the 250^{th} cycle with the capacity of <5 mAh g⁻¹ (FIG. 7d).

The phenomenon of obtained high performance for primary nanoparticles is a result of fast Li⁺ ion diffusion and transport kinetic characteristics in comparison with secondary microparticles (FIG. 7f). As depicted, secondary microparticles show less fast Li⁺ ion transport at 20 C discharge due to higher Li⁺ ion diffusion length and reduced Li⁺ ion pathways, causing internal side reactions between electrolyte and active material and electrode resistance build-up. By reconstructing secondary microparticles into primary nanoparticles by segregation (micro to nano), modifying the nanoparticle's surface with PMMA+PVdF polymer coating (indicated in blue, FIG. 7f) for preventing direct electrolyte contact and side reactions, and providing a conducting network of CNT for increasing electronic conductivity at 20 C, the overall performance can be greatly improved. Segregated primary nanoparticles provide belong to fast Li⁺ ion transport and diffusivity occurred by multiple Li⁺ ion diffusion pathways, less Li⁺ ion diffusion length and less electrode charge transfer resistance build-up, resulting in two flat voltage region, 82% reversibility for the 11^{th} cycle at 20 C discharge, and a retained flat voltage profile for the 1000^{th} cycle at 4.3 V less polarization (FIG. 7e).

Therefore, the capacity vs. cycle number studies of segregated primary nanoparticles exhibited superior stable cycle performance at 20 C discharge compared to secondary microparticles, as shown in FIG. 7g. The secondary microparticles delivered the charge-discharge capacity of 75/70 mAh g⁻¹ for the 12^{th} cycle at 1 C charge and 20 C discharge and showed drastic capacity loss in subsequent cycles, losing their cycle operation at the 250^{th} cycle with the capacity of less than 5 mAh g⁻¹ due to their large dimension. In contrast, the segregated primary nanoparticles showed superior stable cycle performance and delivered the charge-discharge capacity of 102/100 mAh g⁻¹ for the 12^{th} cycle (82% capacity retention related to the 5^{th} cycle reversible charge-discharge capacity of 126/122 mAh g⁻¹ at 1 C) and 86/86 mAh g⁻¹ for the 1000^{th} cycle (70% capacity retention) with the coulombic efficiency of ˜99.4% during cycles (FIG. 7g), reflecting excellent high voltage cathode life at high rate. The primary nanoparticle surface covered with PMMA+PVdF polymer layer prevents hydrofluoric (HF) attacks, hinders side reactions between metal ions and electrolyte, and supports fast Li⁺ ion conduction for high-rate charge-discharge studies. At high rate, the electrical contact problems of the segregated primary nanoparticles were overcome by the engineering of the electrode architecture with a conducting network of CNT. From the cycling results, segregated primary nanoparticles with surface-coating of PMMA+PVdF polymer layer and conducting network of CNT have a strong potential for use as a highly durable, cobalt-free, high voltage cathode of high rate discharge in LIBs.

In summary, secondary microparticles composed of primary nanoparticles synthesized at 800° C. for 12 hours using Mn_{1.5}Ni_{0.5}(OH)₂CO₃ precursor, releasing gaseous species of CO₂ and H₂O upon thermal decomposition and calcination. Ex-situ and in-situ high-temperature powder XRD patterns showed the least disordered phase spinel LiMn_{1.5}Ni_{0.5}O₄ cathode without the rock-salt impurity phase LiₓNi₁₋ₓO₂. Raman bands of secondary microparticles and primary nanoparticles at 590 cm⁻¹ (F_{2g}⁽³⁾) were detected without splitting, confirming with the least disordered phase of Fd3̅m structure, having insignificant content of Mn³⁺ ions to greater electronic and ionic conductivities of the material. The surface morphology results showed secondary microparticles with the size of ˜1 μm composed of primary nanoparticles and segregated primary nanoparticles having a surface coating-networking of the PMMA+PVdF polymer layer and conducting network of CNTs, displayed well dispersed primary particles aligned in a uniform pattern indicating surface smoothness. The CV results of primary nanoparticles revealed well-resolved two redox peaks at 4.7 V for Ni²⁺ to Ni³⁺ and Ni³⁺ to Ni₄₊ process with higher current intensity than the secondary microparticles, associated with the redox process of Ni²⁺ to Ni³⁺ and Ni³⁺ to Ni⁴⁺, confirming a two-stage Li⁺ ion deintercalation and intercalation process occurring at 4.7 V. EIS spectra of primary nanoparticles before and after 5 cycles CV were almost overlapped and displayed less charge transfer resistance of R_{ct}˜91Ω and R_{ct}˜102Ω, compared to secondary microparticles which displayed resistances of R_{ct}˜123Ω for fresh and R_{ct}˜159Ω for after 5 cycles CV.

Primary nanoparticles showed clear two flat voltage plateaus at 4.7 V and delivered high reversible capacity of 112 mAh g⁻¹ at the 10^{th} cycle, 109 mAh g⁻¹ at the 100^{th} cycle and 100 mAh g⁻¹ at the 500^{th} cycle compared to secondary microparticles delivered discharge capacities of 109 mAh g⁻¹ at the 10^{th} cycle, 96 mAh g^{'1} at the 100^{th} cycle, and 87 mAh g 1 at the 500^{th} cycle at 1 C between 4.0-4.9 V. Rate durability cycling studies at 1 C charge and 20 C discharge, segregated primary nanoparticles delivered the charge-discharge capacities of 102/100 mAh g⁻¹ for the 12^{th} cycle and 86/86 mAh g⁻¹ for the 100^{th} cycle, while secondary microparticles delivered lower charge-discharge capacity of 75/70 mAh g⁻¹ for the 12^{th} cycle with drastic capacity decay and declined its cycle at the 250^{th} cycle with the capacity of 5 mAh g⁻¹. Thus, segregated primary nanoparticles with surface-coating of PMMA+PVdF polymer layer and conducting network of CNT have a strong potential for use as a highly durable, cobalt-free, high voltage cathode capable of high rate discharge in LIBs.

### Methods

The following methods can be followed to synthesize and test the high-performance dual particle structure cathode materials described herein.

Secondary microparticles can be converted into primary nanoparticles by segregation, and the primary nanoparticles can be surface modified with PMMA+PVdF polymer coating and providing an enhanced conducting network using multi-walled carbon nanotubes (“MWCNT”) for high-voltage cathode life at high-rate. To derive secondary microparticles, a stoichiometric aqueous mixture solution of Mn(NO₃)₂·4H₂O and Ni(NO₃)₂·6H₂O can be added to a mixture solution of 2 M NaOH and 1 M Na₂CO₃ at 40° C. with stirring, to produce a mixed hydroxy carbonate (MHC) precursor, namely Mn_{1.5}Ni_{0.5}(OH)₂CO₃ as precipitate. After filtration and washing, the precipitate can be dried at 115° C. for 12 hours in a vacuum oven. Subsequently, the Mn_{1.5}Ni_{0.5}(OH)₂CO₃ precursor can be homogenized by mixing with Li₂CO₃ precursor, and the blend can be subjected to simultaneous thermal decomposition and calcination process using a desired temperature of at 500° C., 800° C. or 900° C. for 12 hours in air. During thermal decomposition and calcination, Li₂CO₃ and Mn_{1.5}Ni_{0.5}(OH)₂CO₃ precursor containing OH⁻ and (CO₃)²⁻ anions release gaseous species of CO₂ and H₂O, leaving behind well-dispersed secondary microparticles of spinel LiMn_{1.5}Ni_{0.5}O₄ cathode, each of which are composed of primary nanoparticles bound together. The secondary microparticles can then be added into a polymer solution containing 2% of polymethyl methacrylate (PMMA, wt. %) and 2% of polyvinylidene fluoride (PVdF, wt. %) binders in acetone, and the mixture can be vigorously stirred for 1 hour in a Teflon-lined autoclave. This causes secondary microparticles segregation into primary nanoparticles, which are then coated with the polymer to maintain their separation. Then, multi-walled carbon nanotubes (MWCNTs, 2% in wt.) can be added to the mixture and the combined mixture can be stirred for 12 hours at 70° C. This enables the MWCNTs to attach to the polymer coating and create an enhanced conducting network on the primary nanoparticles. The resulting combination can then be placed in an oven for 10 hours at 90° C. and cooled down to room temperature. After that, acetone solvent evaporated at or above 60° C. and obtained primary nanoparticles having the surface coating of PMMA+PVdF and conducting network of CNTs.

To examine the precursors thermal decomposition and the formation of spinel LiMn_{1.5}Ni_{0.5}O₄ cathode, thermogravimetric analysis (TGA) of the homogenized blend contains stoichiometric amounts of Mn_{1.5}Ni_{0.5}(OH)₂CO₃ and Li₂CO₃ precursors can be carried out between room temperature to 950° C. in an air atmosphere with the heating rate of 10° C. min⁻¹ using TGA Q50 instrument. The disorder phase formation and the phase purity of the spinel LiMn_{1.5}Ni_{0.5}O₄ cathode can be investigated by ex-situ and in-situ Powder X-ray diffraction analyses recorded between 10-80° (2θ), using PANalytical Empyrean equipped with Anton Paar High-temperature control unit. Fourier-transform infrared spectroscopic technique with a Nicolet iS50 FTIR Spectrometer can be used to determine the Mn and Ni ordering distribution of secondary microparticles (derived at 800° C. for 12 h) and segregated primary nanoparticles for disordered phase spinel LiMn_{1.5}Ni_{0.5}O₄ cathode. The disordered phase of spinel LiMn_{1.5}Ni_{0.5}O₄ cathode can be determined by Raman spectroscopy measurements using a Horiba T64000 spectrometer equipped with a DXR green laser (532 nm). The surface morphology, particle size, energy dispersive X-ray spectrum, and the simultaneous elemental mapping analyses can be performed by field-emission scanning electron microscopic (FESEM) analyses using Helios SEM FIB. The secondary microparticles and segregated primary nanoparticles with surface coating of PMMA+PVdF polymer layer and conducting network of CNT can be investigated by transmission electron microscopic (TEM) analyses with selected area electron diffraction (SAED) patterns using Zeiss Libra 200 MC.

The kinetic reversibility, Li⁺ ion transport, and Li⁺ ion intercalation and deintercalation features can be inspected by cyclic voltametric (CV) analyses, electrochemical impedance spectroscopic (EIS) measurements and the Galvanostatic charge-discharge cycling studies using fabricated lithium cells of Li vs. secondary microparticles and Li vs. primary nanoparticles. The lithium cells can be assembled using either secondary microparticles or primary nanoparticles of disordered phase spinel LiMn_{1.5}Ni_{0.5}O₄ cathode, lithium metal foil (˜100 μm thickness) as anode, Celgard polypropylene separator, and a mixture solution contains 98% of 1M LiPF₆ in EC+December (1:1 vol %) electrolyte and 2% of fluoroethylene carbonate (FEC) additive. The cathode of respective secondary microparticles/primary nanoparticles can be fabricated using MTI laminate coater with doctor-blade method. A homogenized cathode slurry containing 80% of active material (secondary microparticles/primary nanoparticles), 10% super carbon and 10% polyvinylidene binder dissolved in N-methyl-2-pyrrolidone solvent can be prepared by Thinky planetary mixer and coated on aluminum foil current collector, finally dried at 80° C. for 12 h in a vacuum oven. The dried cathode can be calendered by roll press and cut with the size of 14.5 mm diameter contains the active material loading mass of ˜9 mg. The lithium cells of secondary microparticles and primary nanoparticles can be assembled in a glovebox (VTI Vacuum Technology Corp.), filled with argon, and monitored O₂ and H₂O levels at <0.01 ppm. The reversible kinetic characteristics can be examined by CV analyses using Biologic Potentiostat/Galvanostat instrument (VSP-150) between 3.0 to 4.9 V at 0.05 mV s⁻¹ for 1-5 cycles for fabricated lithium cells of Li vs. secondary microparticles and Li vs. primary nanoparticles. The charge transfer resistance and Li⁺ ion transport characteristics of secondary microparticles and segregated primary nanoparticles for disordered phase spinel LiMn_{1.5}Ni_{0.5}O₄ cathode can be determined by EIS measurements using Biologic Potentiostat/Galvanostat instrument (VSP-150) in the range of 300 kHz to 20 mHz at 10 mV amplitude. The Galvanostatic charge-discharge cycles and rate studies can be performed using Biologic cycler (BCS-805 Module) at 20° C. (±2° C.) for fabricated lithium cells of Li vs. secondary microparticles and Li vs. primary nanoparticles in the voltage range 3.0-4.9 V and 4.0-4.9 V at different rates (1 C, 2 C, 3 C, 5 C, 10 C, 15 C and 20 C).

The embodiments described herein are not limited in their application or use to the details of construction and arrangement of parts and steps illustrated in the drawings and description. Features of the illustrative embodiments and variants may be implemented or incorporated in other embodiments, variants, and modifications, and may be practiced or carried out in various ways. Furthermore, unless otherwise indicated, the terms and expressions employed herein have been chosen for the purpose of describing the illustrative embodiments of the present invention for the convenience of the reader and are not for the purpose of limiting the invention. Having described the invention in detail and by reference to preferred embodiments thereof, it will be apparent that modifications and variations are possible without departing from the scope of the invention which is defined in the appended claims.

What is claimed is:

1. A lithium battery including an anode and a cathode, wherein the cathode comprises lithium manganese nickel oxide spinel having a dual particle structure, the dual particle structure including primary nanoparticles having a mean particle size of less than 50 nanometers segregated from secondary microparticles having a mean particle size of at least one micron, wherein the primary nanoparticles are coated with a polymer coating and connected with a conducting network.

2. The lithium battery of claim 1, wherein the primary nanoparticles have a mean particle size ranging from about 1 to about 900 nanometers and the secondary microparticles have a mean particle size ranging from about 1.05 to about 2 microns.

3. The lithium battery of claim 1, wherein the polymer coating comprises polymethyl methacrylate, polyvinylidene fluoride, or a combination thereof.

4. The lithium battery of claim 1, wherein the polymer coating comprises polymethyl methacrylate and polyvinylidene fluoride.

5. The lithium battery of claim 1, wherein the primary nanoparticles have a mean particle size of about 1 nm to about 45 nm.

6. The lithium battery of claim 1, wherein the primary nanoparticles have a mean particle size of about 5 nm to about 40 nm.

7. The lithium battery of claim 1, wherein the dual particle structure comprises about 20% to about 80% by weight of the primary nanoparticles and about 20% to about 80% by weight of the secondary microparticles.

8. The lithium battery of claim 1, wherein the cathode further comprises multi-walled carbon nanotubes mixed with the polymer coating.

9. A cathode material for a lithium battery, lithium manganese nickel oxide spinel having a dual particle structure, the dual particle structure including primary nanoparticles having a mean particle size of less than 50 nanometers segregated from secondary microparticles having a mean particle size of at least one micron, wherein the primary nanoparticles are coated with a polymer coating and connected with a conducting network.

10. The cathode material of claim 9, wherein the primary nanoparticles have a mean particle size ranging from about 1 to about 45 nanometers and the secondary microparticles have a mean particle size ranging from about 1.05 to about 2 microns.

11. The cathode material of claim 9, wherein the polymer coating comprises polymethyl methacrylate, polyvinylidene fluoride, or a combination thereof.

12. The cathode material of claim 9, wherein the polymer coating comprises polymethyl methacrylate and polyvinylidene fluoride.

13. The cathode material of claim 9, further comprising multi-walled carbon nanotubes mixed with the polymer coating.

14. The cathode material of claim 12, further comprising multi-walled carbon nanotubes mixed with the polymer coating.

15. The cathode material of claim 9, wherein the dual particle structure comprises about 20% to about 80% by weight of the primary nanoparticles and about 20% to about 80% by weight of the secondary microparticles.

16. A method of preparing a cathode material having a dual particle structure, comprising the steps of:
preparing secondary microparticles of spinel lithium manganese nickel oxide having a mean particle size of at least one micron;
segregating the microparticles into primary nanoparticles having a mean particle size of less than about 50 nanometers;
applying a polymer coating on the primary nanoparticles; and
connecting the primary nanoparticles together using a conducting network.

17. The method of claim 16, wherein the step of preparing the microparticles comprises:
adding a solution containing Mn(NO₃)₂·4H₂O and Ni(NO₃)₂·6H₂O to a mixture solution containing NaOH and Na₂CO₃ with stirring to produce a hydroxy carbonate (MHC) precursor mixture that includes Mn_{1.5}Ni_{0.5}(OH)₂CO₃ as precipitate;
filtering the precipitate from the mixture;
washing and drying the precipitate;
mixing the precipitate with a Li₂CO₃ precursor to form a blend; and
heating the blend to a temperature of at least about 500° C. for a time sufficient to cause thermal decomposition and calcination, releasing quantities of CO₂ and H₂O and yielding the microparticles.

18. The method of claim 17, wherein the temperature is at least about 800° C. and the time is at least about 12 hours.

19. The method of claim 16, wherein the step of converting some of the microparticles into the nanoparticles comprises:
adding the microparticles with a solution including a solvent and a polymer;
mixing the microparticles and solution with sufficient stirring to cause some of the microparticles to segregate into the nanoparticles and application of a polymer coating to the nanoparticles; and
heating the solution to cause removal of the solvent, yielding polymer-coated nanoparticles.

20. The method of claim 19, wherein the polymer is selected from the group consisting of polymethyl methacrylate, polyvinylidene fluoride, and combinations thereof.

21. The method of claim 19, wherein the solution further comprises multi-walled carbon nanotubes and the polymer coating further comprises the multi-walled carbon nanotubes.
